(19) United States
(12) Patent Application Publication
(10) Pub. No.: US 2019/0375658 A1
(43) Pub. Date: Dec. 12, 2019

(54) WATER TREATMENT SYSTEM WITH DISINFECTANTS

(71) Applicant: Medora Environmental, Inc., Dickinson, ND (US)

(72) Inventors: Adam G. Ness, Dickinson, ND (US); Corey M. Simnioniw, Belfield, ND (US); Joel J. Bleth, Dickinson, ND (US); Willard R. Tormaschy, Dickinson, ND (US); Jonathan L. Zent, Dickinson, ND (US)

(73) Assignee: Medora Environmental, Inc., Dickinson, ND (US)

(21) Appl. No.: 16/435,027

(22) Filed: Jun. 7, 2019

Related U.S. Application Data
(60) Provisional application No. 62/683,544, filed on Jun. 11, 2018.

(51) Int. Cl. C02F 1/68; C02F 1/00; C02F 1/76

(52) U.S. Cl. CPC C02F 1/686; C02F 1/008; C02F 1/76; C02F 2307/14; C02F 2209/44; C02F 2303/04; C02F 2209/40

(57) ABSTRACT

A water treatment system (1) for a reservoir (3) of water (5) including a mixing unit (2) located outside of the reservoir (3) and in an overall flow path of water from the reservoir (3) to and through the mixing unit (2) and back into the reservoir water (5). The mixing unit (2) is operable in three disinfectant modes that selectively add (a) chlorine, (b) ammonia, or (c) a blended mixture of chlorine and ammonia forming chloramines into the water returning to the reservoir (3). The mixing unit (2) also has hard and soft flush modes. In the hard flush mode, water (5) from the reservoir (3) is continually moved to flush through the mixing unit (2) and back to the reservoir (3). In the soft flush mode, the incoming hard water (5) from the reservoir (3) is softened to remove calcium and other minerals before passing through the mixing unit (2) and back to the reservoir (3) to reduce the undesirable build up of mineral deposits in the mixing unit (2).

### RELATED APPLICATIONS

This application claims the benefit of U.S. Provisional Patent Application Ser. No. 62/683,544 filed Jun. 11, 2018, which is incorporated herein by reference.

### BACKGROUND OF THE INVENTION

### 1. Field of the Invention

This invention relates to the field of water treatment systems for reservoirs including municipal water tanks and pipelines as well as other industrial and commercial processes requiring disinfectant delivery and distribution. This invention particularly relates to the field of such systems that monitor and selectively add disinfectants such as chlorine, ammonia, and mixtures of chlorine and ammonia forming chloramines to the water in the reservoir.

### 2. Discussion of the Background

Water treatment systems have made great advances in creating safe drinking water by closely monitoring the water in reservoirs such as municipal water tanks and selectively adding chlorine, ammonia, and mixtures of chlorine and ammonia forming chloramines to the reservoir water. Although very effective, such disinfectants can be extremely difficult and somewhat dangerous to handle not only for the operators of the equipment but also for the equipment itself. All chlorine contact with the operators in particular is to be avoided if possible. In turn, protection of the equipment itself from the disinfectants especially the corrosive nature of the chlorine as well as from the scaling or build up of calcium and other mineral deposits from the reservoir water (which typically contains enough mineral hardness to cause issues associated with chlorine injection) must also be sought as much as possible. Consequently, any design of the equipment and its operation must be carefully made with these matters in mind and especially the potential dangers of working with the disinfectants themselves.

In this last regard, it has been widely observed when disinfectants are introduced into water bodies that include static zones in between treatments that internal corrosion and scaling of pumps and plumbing can quickly occur. Liquid metering pumps are particularly prone to such problems when operated to pump disinfectant and then stopped until another disinfectant is needed. Such start and stop operation undesirably allows concentrated, corrosive liquid to remain static inside the pump introducing accelerated corrosion and scaling. Other plumbing parts of such conventional systems that cycle between flow and no-flow disinfectant conditions are equally subject to undesirable scaling and plugging completely within a relatively short amount of time due to the chemical reactions occurring at their points of contact, especially during such non-flow, static conditions. Further complicating such conventional systems that are automated is that without frequent adjustments and maintenance to address the reduced performance of their corroded pumps and/or blocked plumbing, the overall operation and effectiveness of the systems are greatly compromised and can be drastically reduced in relatively short order.

With these and other problems in mind, the present invention was developed. In it, a water treatment system is disclosed that is designed to minimize any undesirable contact by the operators with the disinfectants and to minimize the potential damage to the equipment and its parts from the corrosive nature of the disinfectants being added and from any scaling due to calcium and other mineral deposits from the reservoir water which is typically hard water.

### SUMMARY OF THE INVENTION

This invention involves a water treatment system for a reservoir of water and includes a mixing unit located or positioned outside of the reservoir and in an overall flow path of water from the reservoir to and through the mixing unit and back into the reservoir water. The mixing unit is operable in a number of different modes including three disinfectant ones that selectively add (a) chlorine, (b) ammonia, or (c) a blended mixture of chlorine and ammonia forming chloramines into the water returning to the reservoir. The mixing unit also has a hard flush mode and a soft flush mode. In the hard flush mode, water from the reservoir (which typically contains enough mineral hardness to cause issues associated with chlorine injection) is continually moved from the reservoir to and through the mixing unit and back to the reservoir. In doing so, it continually flushes or moves cleansing water through the mixing unit and its parts. In the soft flush mode, the incoming water from the reservoir is diverted in the mixing unit to pass through a water softener to remove calcium and other minerals before passing through the mixing unit and back to the reservoir. This soft flush in particular reduces problems with scaling or build up of calcium and other mineral deposits in the mixing unit and its parts.

In the preferred manner of operation, the hard flush mode is normally always in use when no disinfectants are being added. However, once it is determined that one of the three disinfectant modes (a)-(c) is desirable, a control arrangement switches the mixing unit to the soft flush mode to eliminate or at least greatly reduce the calcium and other minerals in the incoming water from the reservoir (which again is typically hard water containing enough mineral hardness to cause issues associated with chlorine injection). The control arrangement then switches the mixing unit to one of the three disinfectant modes of (a)-(c) depending upon which mode is desired based on analyses of the incoming water to the mixing unit from the reservoir. The desired disinfectant or disinfectants are then added to the softened water passing through the mixing unit and back to the reservoir. Depending upon feedback from analyzing the effects of the particular disinfectant mode originally chosen, one or more of the other modes may also be employed until the desired feedback results are achieved.

Thereafter and once it is determined from the feedback that the desired amount of disinfectant or disinfectants are present in the water in the reservoir and regardless of which disinfectant mode or modes were in use, the disinfectant or disinfectants are stopped from being introduced into the water passing through the mixing unit. However, the incoming water from the reservoir to the mixing unit is still preferably diverted through the water softener and a soft flush is done after the disinfectant mode or modes. This further serves to protect the mixing unit and its parts from scaling and corrosion after which the mixing unit is returned to the hard flush mode until another disinfectant mode is determined to be desirable.

### BRIEF DESCRIPTION OF THE DRAWINGS

FIGS. 1-2 illustrate the overall structure of the water treatment system of the present invention including the mixing unit that is located or positioned outside of the reservoir (e.g., municipal water tank) to be treated.

FIGS. 3-4 schematically illustrate the mixing unit of the present invention in its hard flush mode (FIG. 3) and soft flush mode (FIG. 4) to respectively flush or cleanse the mixing unit when not in a disinfectant mode of FIGS. 5-7.

FIGS. 5-7 schematically illustrate the mixing unit in its three disinfectant modes of adding chorine (FIG. 5), adding ammonia (FIG. 6), and adding a blend of both chlorine and ammonia to form chloramines (FIG. 7).

FIG. 8 shows the flow control valve or member for the chlorine addition of FIG. 5 in its position to permit the flow of chlorine from the bulk storage tank of chlorine of FIG. 5 into the flow path section passing through the mixing unit.

FIG. 9 is an enlarged, cross-sectional view of the eductor in the chlorine addition mode of FIG. 5 in operation to draw chlorine from the bulk storage tank of chlorine in FIG. 5 through the chlorine flow control valve or member of FIG. 8 and into the main flow path section passing through the mixing unit.

FIG. 10 is a view similar to FIG. 8 but showing the flow control valve or member of FIG. 8 positioned to block or prevent the addition of chlorine from the bulk storage tank of chlorine and to permit flushing or cleansing in the hard and soft flush modes of FIGS. 3-4 and the ammonia addition mode of FIG. 6.

FIGS. 11-13 show various parts of the blending tank of the mixing unit in various modes of operation including introducing both chlorine and ammonia to form chloramines in FIGS. 11-12 and introducing just one of the disinfectants (e.g., ammonia) in FIG. 13.

FIGS. 14a-14d illustrate further details of the blending tank including some dimensions of its parts.

FIG. 15 shows the inclusion of a static mixer in the inlet tubes to the blending tank to aid in mixing the incoming chlorine and/or ammonia by increasing the turbulence in the inlet tubes and helping to break up any undesirable clumps or slugs in the incoming disinfectants.

FIG. 16 is a breakpoint chlorination curve illustrating various conditions that may exist in the water in the reservoir.

FIGS. 17-18 illustrate further details of the main circulator in the water reservoir and how the disinfectants from the mixing unit are introduced essentially at the water inlet to the submerged circulator in FIG. 17 and mixed within the circulator before being discharged from the circulator up into the water of the reservoir to drive the circulation of the water in the reservoir.

FIG. 19 shows the water treatment system of the present invention in use in the environment of a floating circulator for the reservoir such as might be used in a municipal water tank as in FIGS. 1-2 or a water reservoir open to atmosphere such as a pond or lake.

FIGS. 20-21 illustrate the basic design of the mixing unit of the present invention in use operating in an environment in which the water reservoir to be treated is a pipeline of flowing water adjacent the mixing unit.

FIGS. 22-26 illustrate some of the more desirable manners or schemes of operating the mixing unit including selectively varying the order and length of the disinfectant modes as well as the flushes or cleansing rinses between them.

### DETAILED DESCRIPTION OF THE INVENTION

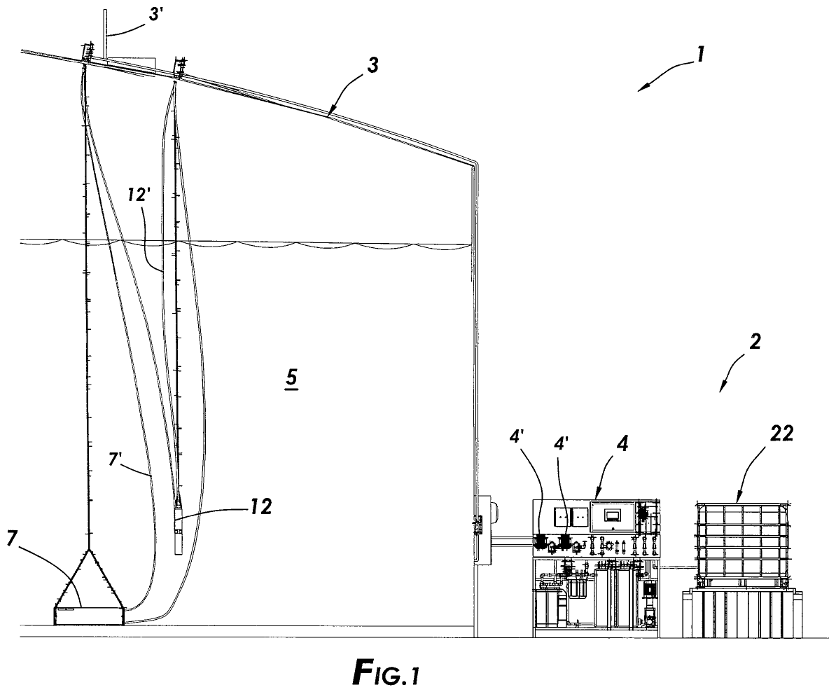

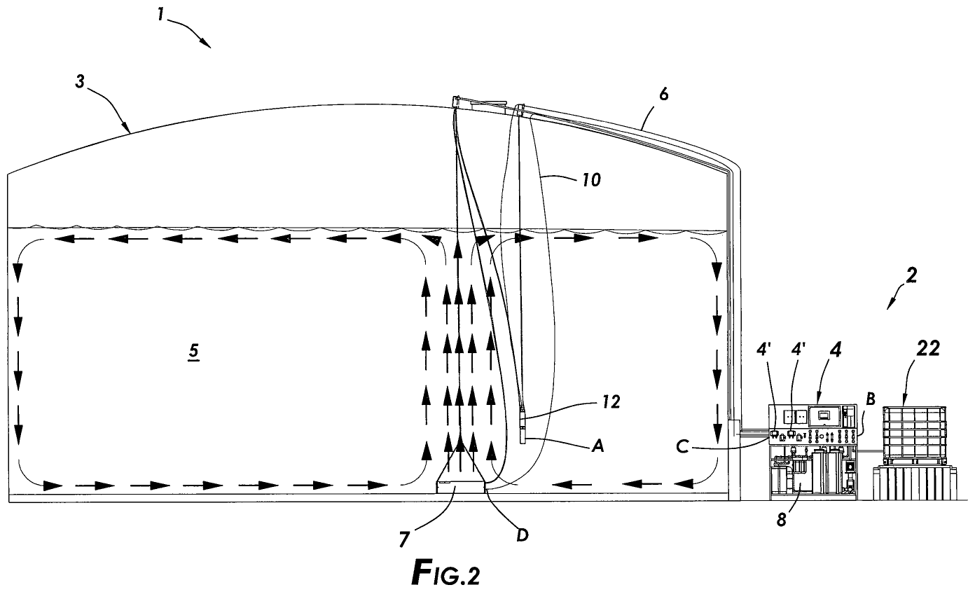

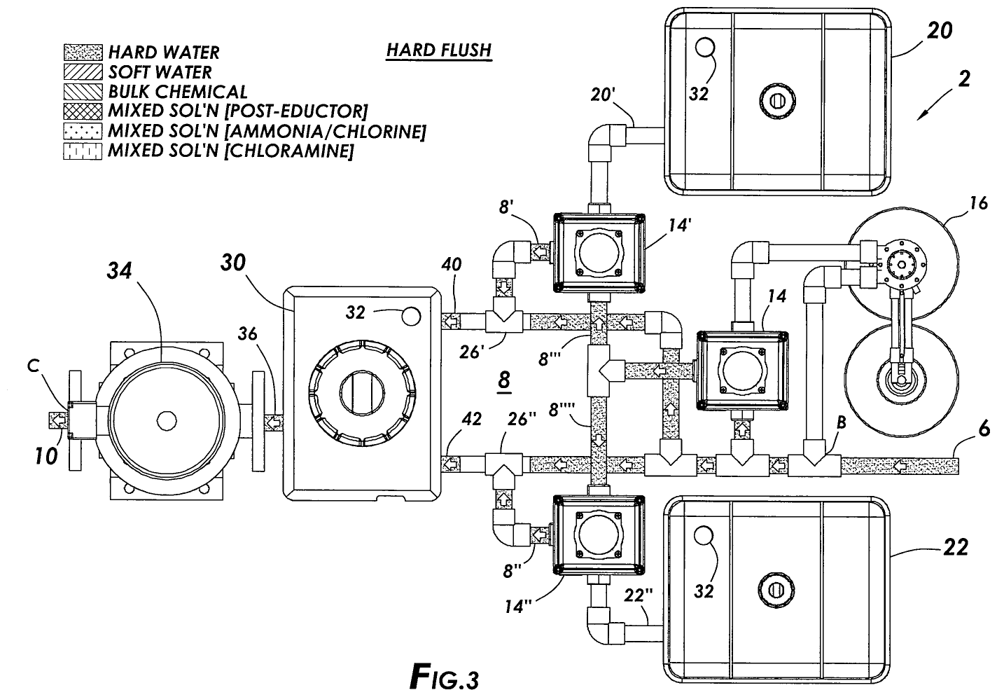

The water treatment system 1 of the present invention includes the disinfectant mixing unit 2 of FIG. 1 which is positioned or located outside of the reservoir 3 (e.g., tank) of water 5. The mixing unit 2 for disinfectants such as chlorine, ammonia, and blended mixtures of chlorine and ammonia forming chloramines is operable by the control arrangement 4 in a number of modes. In one mode, the water 5 from the reservoir 3 is moved to and through the mixing unit 2 and back to the reservoir 3 along an overall flow path of sections 6, 8, and 10 (see FIGS. 2-3). The water in this mode flows from the water reservoir 3 at location A in FIG. 2 up and through section 6 to the location B at the entrance to the mixing unit 2 (see FIG. 3), through the mixing unit 2 via flow path section 8 from location B to location C in FIG. 3, and back into the reservoir 3 through flow path section 10 from location C to location D in FIGS. 2-3. In this mode, no disinfectants are added by the mixing unit 2 into the water flow in the flow path sections 8,10. Rather, the purpose of this mode is to create a continuous flushing or cleansing action through the flow path sections 8,10 and in particular through the path section 8 through the mixing unit 2 (i.e., from location B to location C in FIG. 3). Since the reservoir water 5 contains a significant amount of calcium and other minerals, this mode of operation of FIGS. 2-3 is then essentially a continuous hard flush of the overall water flow path through its sections 6,8,10 from location A in the reservoir 3 (FIG. 2) to the mixing unit 2 at location B (FIGS. 2-3), through the mixing unit 2 (FIG. 3) to location C, and from location C back into the reservoir 3 at location D (FIG. 2).

More specifically and in this hard flush mode, water 5 from the reservoir 3 in FIG. 2 is pumped by the submerged pump 12 up and along the first flow path section 6 to the mixing unit 2 (i.e., from location A to location B). The first section 6 delivers the reservoir water 5 (e.g., 4-5 gallons per minute at 10-40 or more psi) to the T-joint at location B in FIG. 3. Thereafter and with the control arrangement 4 of FIG. 2 positioning the main or primary flow control valve or member 14 open in FIG. 3, the water then flows through the mixing unit 2 along the second path section 8 from the location B to the discharge location C on the left side in FIG. 3 and into the third path section 10 leading back to the water reservoir 3 of FIG. 2. In the illustrated embodiment of FIGS. 1-3, the third path section 10 discharges into the main circulator 7 for the water reservoir or tank 3 at location D in FIG. 2. In this mode of operation, a continuous portion of the incoming hard water from the first flow path section 6 passes through the main control valve or member 14 and on to and through the other control valves or members 14′,14″ as shown in FIG. 3. As discussed in more detail below and as also shown in FIG. 3, another continuous portion of the incoming hard water from section 6 passes directly from section 6 to and through the eductors 26′,26″ bypassing the main control valve or member 14.

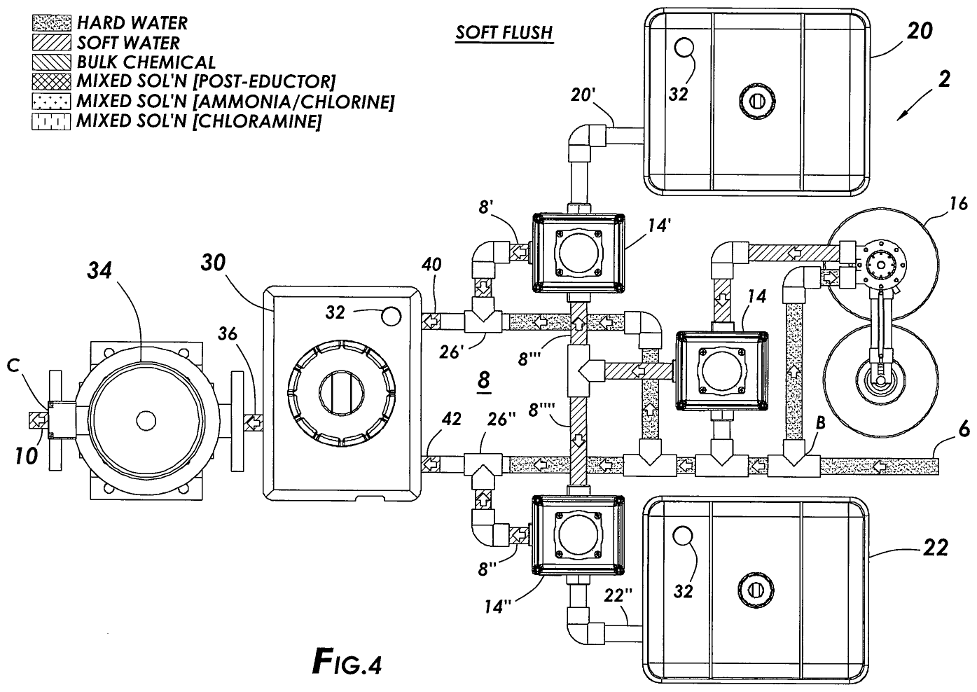

In a second mode of operation, the main control valve or member 14 in FIG. 4 is positioned by the control arrangement 4 to prevent hard water from water path section 6 from passing through the main flow control valve or member 14 in the manner of the mode of FIG. 3. In doing so, a portion of the incoming water in the first path section 6 is then diverted at location B to and through the water softener arrangement 16 upstream of the flow control member 14 and through the second path section 8 to the discharge location C. The water softener arrangement 16 removes calcium and other minerals from the diverted portion of the incoming hard water in the first path section 6 from the reservoir 3. The water softener arrangement 16 then serves to eliminate or at least greatly reduce any undesirable scaling (e.g., calcium and other mineral deposits or build up) in the second path section 8 passing through the mixing unit 2. When operated without the addition of any disinfectants, this mode like the first mode of FIG. 3 serves to perform a flushing or cleansing function of the second and third flow path sections 8,10 but it is done with softened water and is therefore a more desirable flush.

It is noted that at least all of the main working parts of the mixing unit 2 including the flow control valves or members 14,14′,14″ as well as the eductors 26′,26″ are preferably then flushed or cleansed in this mode. Additionally, the third flow path 10 is flushed or cleansed with softened water. However, as mentioned above, the remaining portion of incoming hard water from the first flow path 6 not diverted into the water softener arrangement 16 is preferably allowed to flow directly to the respective eductors 26′,26″ where it is mixed with softened water from the respective flow control valves or members 14′,14″. This direct flow to the respective eductors 26′,26″ helps to reduce the salt consumption in the arrangement 16 used to soften the water and reduce the overall use of softened water in the system 1 itself offering cost savings and increased efficiencies. In this last regard, it has been found that the continuous hard water flow to the eductors 26′,26″ in both the hard and soft flushes of FIGS. 3-4 is sufficient to keep these paths clean enough so as not to adversely affect the chemical injection processes discussed below. Nevertheless and although only a portion of the incoming hard water is preferably diverted to the water softener arrangement 16, all of the incoming hard water could be diverted to the arrangement 16 if desired.

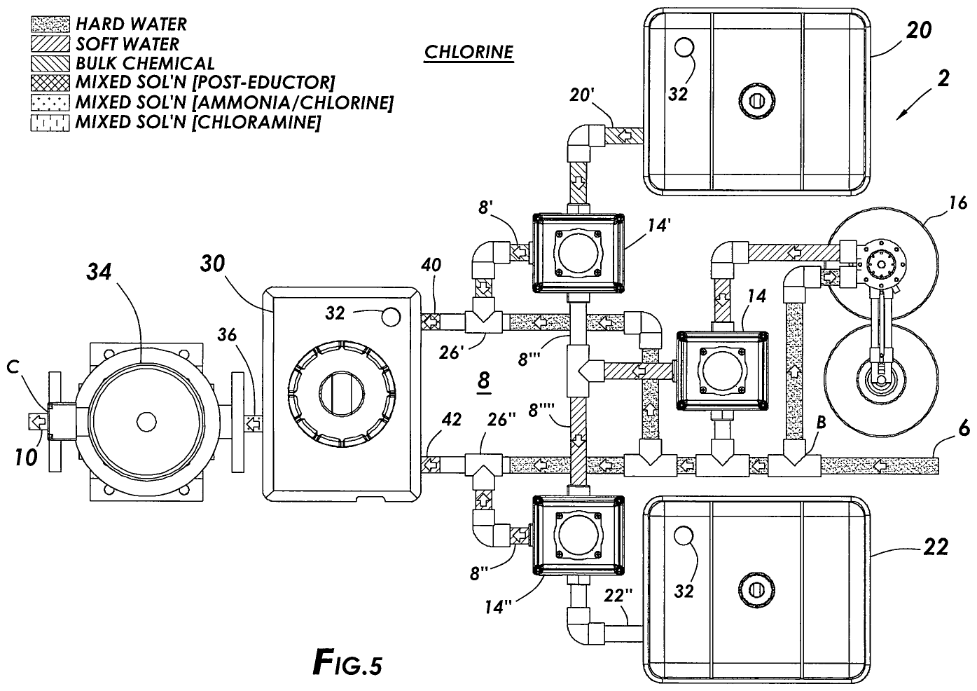

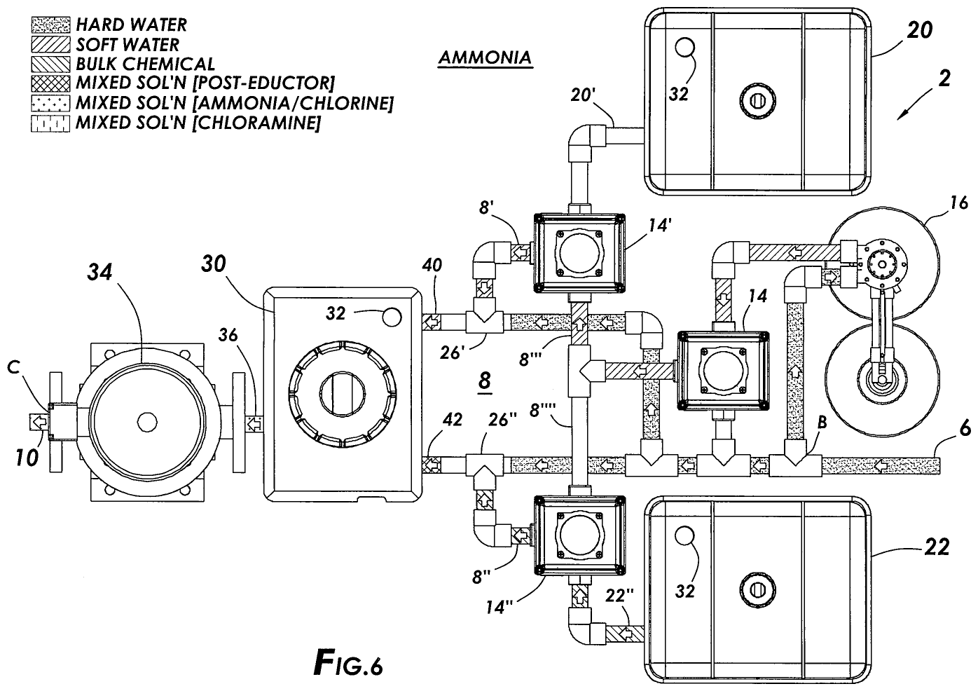

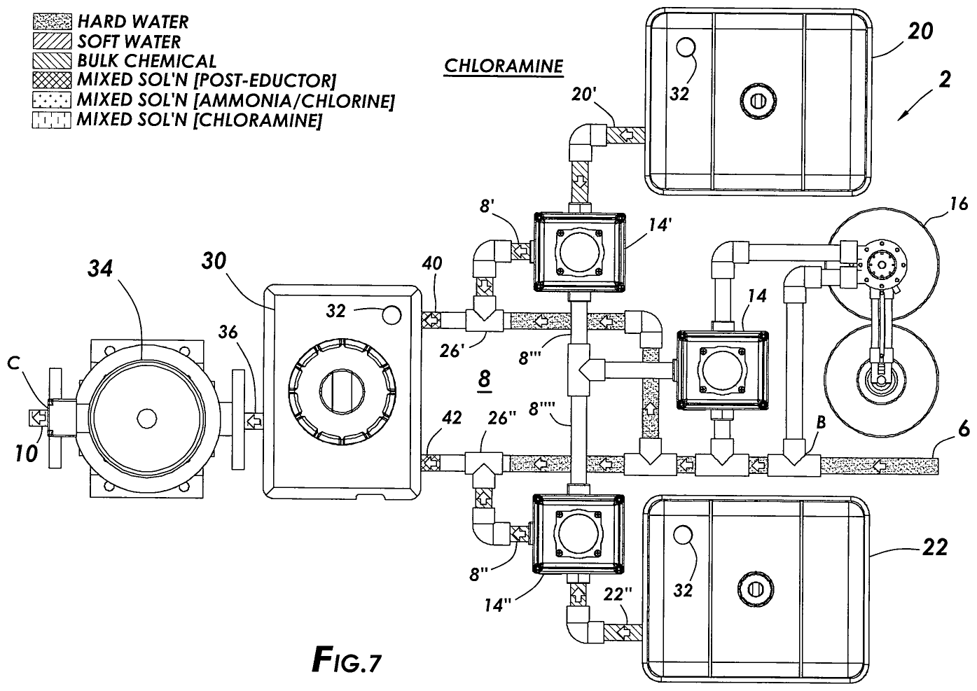

The mixing unit 2 in the disinfectant modes of operation of FIGS. 5-7 serves to selectively (a) add chlorine (e.g., liquid chlorine in the form of 12.5% liquid sodium hypochlorite) in the configuration of FIG. 5 from the first bulk storage tank 20 into the second flow section 8 flowing through the mixing unit 2, (b) add ammonia (e.g., liquid ammonia in the form of 35%-45% liquid ammonium sulfate) in the configuration of FIG. 6 from the second bulk storage tank 22 into the second flow path section 8, or (c) add both chlorine from the first bulk storage tank 20 and ammonia from the second bulk storage tank 22 in the configuration of FIG. 7 to the second path section 8 to form chloramines. The operation of which of these three disinfecting modes as well as the hard and soft flush modes of FIGS. 3-4 is controlled by the control arrangement 4. This is preferably done automatically using one or more analyzers at 4′ in the control arrangement 4 in FIG. 1-2 to determine the condition of the water 5 from the reservoir 3 flowing into the mixing unit 2; however, it could be done manually if desired. The monitored water condition could be any number of ones including the free chlorine and total chlorine (free and in the form of chloramines) in the incoming water 5. In the illustrated embodiments, the analyzers at 4′ are preferably measuring such free chlorine and total chlorine and the control arrangement 4 operated to drive the mixing unit 2 accordingly as discussed in more detail below.

In the preferred sequence of operation of the hard and soft flushing or cleansing modes of FIGS. 3-4 and the disinfecting modes of FIGS. 5-7, the common or steady state mode is preferably the continuous hard flush one when no need for additional disinfectant is determined by the analyzers at 4′. Once a need for disinfection is determined and regardless of whether it is for chlorine, ammonia, or both chlorine and ammonia to form chloramines, the operation of the mixing unit 2 is preferably switched by the control arrangement 4 to the soft flush mode of FIG. 4. This then prepares the mixing unit 2 for the addition of chlorine as in FIG. 5, ammonia as in FIG. 6, or both chlorine and ammonia to form chloramines as in FIG. 7. The addition of one or both of the disinfectants into softened water rather than into hard water as discussed above greatly helps to reduce undesirable scaling (e.g., calcium and other mineral deposits or build ups) and corrosion (particularly by chlorine) of the operating parts of the mixing unit 2.

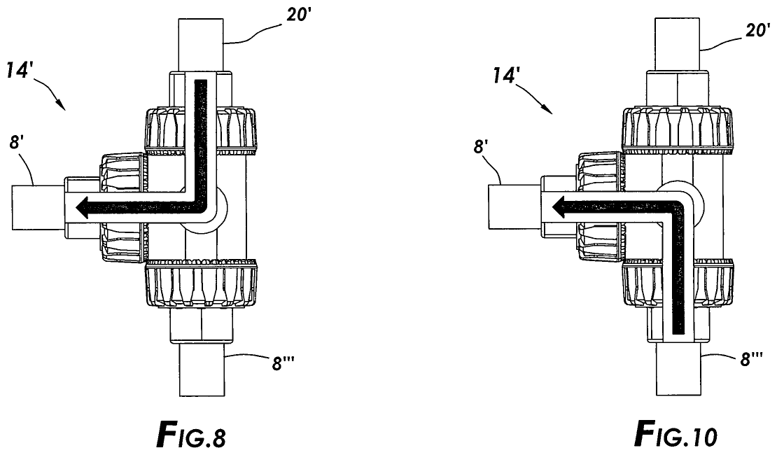

To introduce (a) chlorine into the second flow path section 8 passing through the mixing unit 2 in FIG. 5, the control valve or member 14′ (see FIGS. 5 and 8) is positioned as in FIG. 8 by the control arrangement 4 of FIG. 2 to permit the flow of chlorine from the first bulk storage tank 20 (FIG. 5) through the chlorine flow line 20′ to the second flow path section 8 at its side line 8′ in FIGS. 5 and 8. The chlorine from the first bulk storage tank 20 is then drawn through the chlorine flow line 20′, control member 14′, and side line 8′ in FIGS. 5 and 8 by the suction or venturi effect of the eductor 26′ (see FIGS. 5 and 9) to enter the main flow of the second flow path section 8 leading to the blending tank 30 of the mixing unit 2 (FIG. 5). The operation of the blending tank 30 will be discussed in more detail below but suffice it to say at this point that the blending tank 30 is vented at 32 in FIG. 5 to atmosphere to enhance the delivery of the chlorinated water in this mode into blending tank 30. Once the chlorinated water is at the desired dilution in the blending tank 30 (e.g., based on a meter reading or empirically by time such as 1-2 minutes), the variable speed pump 34 in FIG. 5 preferably draws the chlorinated water out of the bottom of the blending tank 30 through line 36 and delivers it to location C in FIG. 5 and into the third flow path section 10 leading back to the water reservoir 3 of FIG. 2. It is noted as explained in more detail below that the variable speed pump 34 is normally operated to continually handle or match the incoming flow rate (e.g., 4-5 gallons per minute) to the mixing unit 2 from the submerged pump 12 in the reservoir 3 of FIGS. 1-2. However, the variable speed pump 34 can be slowed to allow for additional collection and blending in the blending tank 30 as desired (e.g., based on a meter reading, empirically by time, or volume increase in the blending tank 30). In any event and after the chlorine addition mode of FIG. 5 is completed, the mixing unit 2 as mentioned above is preferably returned to the soft flush mode of FIG. 4 for flushing and cleansing (e.g., 1-2 minutes) and then back to the continuous hard flush mode of FIG. 3 until the next disinfectant mode is desired.

In a similar manner and to introduce (b) ammonia into the second flow path section 8 passing through the mixing unit 2 in FIG. 6, the control valve or member 14″ like the control member 14′ of FIG. 8 is positioned by the control arrangement 4 of FIG. 2 to permit the flow of ammonia from the second bulk storage tank 22 through the ammonia flow line 22″ to the second flow path section 8 at its side line 8″ in FIG. 6. The ammonia from the second bulk storage tank 22 is then drawn through the ammonia flow line 22″, control member 14″, and side line 8″ in FIG. 6 by the suction or venturi effect of the eductor 26″ to enter the main flow of the second flow path section 8 leading to the blending tank 30 of the mixing unit 2. As noted above, the blending tank 30 is vented at 32 in FIG. 6 to atmosphere to enhance the delivery of the ammonia into blending tank 30. The ammonia may be at the desired dilution in the blending tank 30 as delivered or with some blending time in the tank 30. The desired strength may also be achieved by throttling the suction port 8″ of the eductor 26″ to control the volume it pulls (e.g., by needle valves or smaller diameter tubing or incorporating a modulating valve or other control means). The concentration or strength could also be changed by regulating the pressure seen at the inlet to the eductor 26″ or by adding static mixers or otherwise increasing the discharge pressure to alter the performance of the eductor 26″. The flow rate and other characteristics may also be electronically controlled by the use of a pulse width modulation scheme as discussed later. All such methods would change or set the concentration of ammonia, which over time would ideally be set to exit the eductor 26″ at the desired concentration and eliminate the need for any dilution steps in the blending tank 30. In any event and once the desired strength or concentration of ammonia is achieved, the variable speed pump 34 in FIG. 6 preferably draws the mixed ammonia out of the bottom of the blending tank 30 through line 36 and delivers it to location C in FIG. 6 and into the third flow path section 10 leading back to the water reservoir 3 of FIG. 2. After the ammonia addition mode of FIG. 6 is completed, the mixing unit 2 like after the chlorine addition mode of FIG. 5 is preferably returned to the soft flush mode of FIG. 4 for flushing and cleansing and then back to the hard flush mode of FIG. 3 until the next disinfectant mode is desired.

In an equally similar manner to the modes of adding (a) just chlorine or (b) just ammonia above, (c) both chlorine and ammonia to form chloramines can be added to the second flow path section 8 in FIG. 7 by positioning both of the control valves or members 14′,14″ in open positions. This in turn permits the respective flows of chlorine from the first bulk storage tank 20 and ammonia from the second bulk storage tank 22 through the respective chlorine and ammonia flow lines 20′,22″ in FIG. 7 into the respective side lines 8′,8″ and through the respective eductors 26′,26″ to enter the main flow of the second flow path section 8 leading to the blending tank 30 of the mixing unit 2. Once the desired concentration of chloramines in the blending tank 30 is reached (which like above may be as delivered but typically is after some blending time of 1-2 minutes in the tank 30) and as in the chlorine and ammonia modes (a)-(b) above, the blended chloramines of this mode (c) are then drawn out of the mixing tank 30 by the variable pump 34 and delivered into the third flow path section 10 leading back to the water reservoir 3 of FIG. 2. After this mode of (c) is completed, the mixing unit 2 as after modes (a) and (b) is preferably returned to the soft flush mode of FIG. 4 for flushing and cleansing and then back to the hard flush mode of FIG. 3 until the next disinfectant mode is desired.

Although the disinfectant modes (a)-(c) can be done individually between the preceding pair of hard/soft flushes and following pair of soft/hard flushes as discussed above, it is also possible to run multiple combinations of the disinfectant modes after the preceding hard/soft flushes and before the following soft/hard flushes as determined desirable by the analyzers 4′ and control arrangement 4. That is for example and based on a monitoring of the feedback from the reservoir 3, it may be desirable to first run a chlorine only mode (a) followed by an ammonia only mode (b), and/or chlorine and ammonia blend to form chloramines before cycling back through the soft flush to the steady state hard flush until the next disinfectant treatment is desired. This hard flush as mentioned above is preferably run continuously by the control arrangement 4 until the next disinfectant treatment. This is not only to flush and cleanse the mixing unit 2 but also to avoid any cessation of flow through the mixing unit 2 that might result in the corrosion of its parts and in particular any precipitation out of any of the disinfectants or calcium that once so precipitated may be difficult if not impossible to re-dissolve or bring back into solution and/or be cleared by the force of the moving flush. Although the preferred operation of the mixing unit 2 is with a preceding pair of hard/soft flushes and a following pair of soft/hard flushes on each side of one or more of the disinfectant modes (a)-(c), it is also possible to have just a preceding and following hard flush if desired, eliminating the intermediate soft flushes as in FIG. 7. It is also noted that the hard flush as discussed above is with the reservoir water 5 as is and its hardness may vary. However, in any event and as compared to the soft flush, the water softened by the arrangement 16 as in FIG. 4 is typically much softer (e.g., 1/10th or less) than the hardness of the reservoir water 5.

As will be discussed in more detail below and referring again to possible combinations or subcombinations of the basic disinfectant modes (a)-(c), the preferred operation for example of the chlorine and ammonia blend to form chloramines in mode (c) actually includes adding an amount of ammonia beyond what would normally produce all chloramines. Consequently, the blend delivered to the reservoir 3 is really one of chloramines (e.g., 90%) with some free ammonia (e.g., 10%). The additional free ammonia is then present to react with any free chlorine already in the reservoir water 5 to form further chloramines. The condition of always having free ammonia in the reservoir water 5 is normally the preferred one.

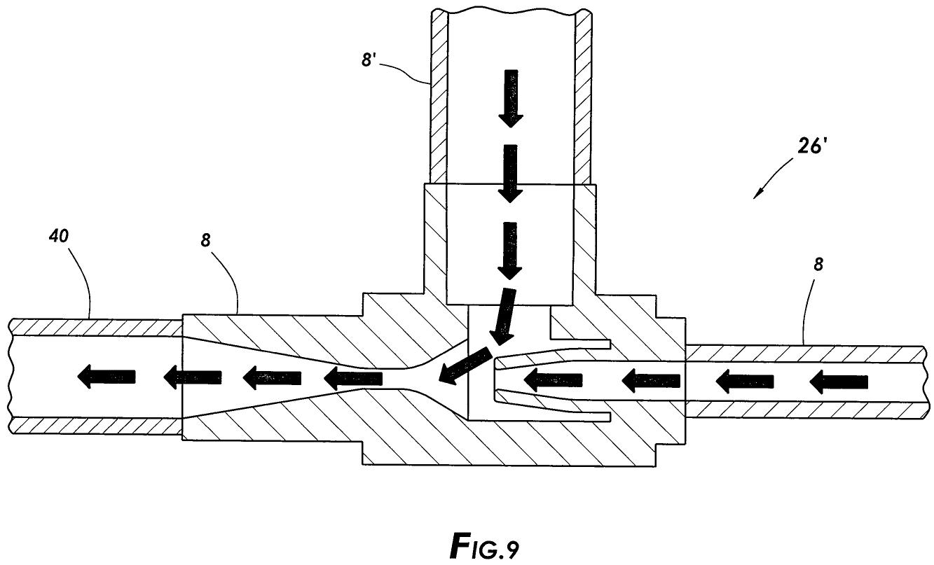

It is noted in the disinfectant chlorine mode (a) of FIG. 5 that the control member 14″ from the second bulk storage tank 22 is positioned to prevent the introduction of ammonia from the bulk storage tank 22. Similarly, the control member 14′ from the first bulk storage tank 20 in the ammonia mode (b) of FIG. 6 is positioned to prevent the introduction of chlorine from the first bulk storage tank 20. It is further noted in conjunction with these closed operations of the control members 14′,14″ in FIGS. 5-6 to prevent the respective introduction of ammonia (FIG. 5) and chlorine (FIG. 6) that a flushing or cleansing flow or rinse continues through the respective control members 14′,14″, side lines 8′,8″, and eductors 26′,26″ when the chlorine in FIG. 5 and ammonia in FIG. 6 are prevented by the respective control members 14′,14″ from entering the second flow path section 8 from their respective bulk storage tanks 20,22. FIG. 10 in this regard illustrates the control member 14′ adjacent the bulk storage tank 20 of chlorine positioned to permit the flow from the main flow control valve or member 14 through the control member 14′ and into the side line 8′ and eductor 26′ of the second flow path section 8 when the ammonia only mode (b) in FIG. 6 is in operation.

The feed lines 8″ and 8″″ in FIG. 5 from the main flow control valve 14 to the respective flow control valves 14′,14″ offer the operating feature that the added chlorine in FIG. 5 and added ammonia in FIG. 6 can be further diluted if desired in the blending tank 30 before being discharged from the blending tank 30 by the variable speed pump 34. That is and if it is determined that the concentration of chlorine in FIG. 5 or ammonia in FIG. 6 is too strong in the mixing tank 30, the variable pump 34 can be slowed down or its discharge restricted. With the respective flow control valve 14′,14″ also restricted to reduce the incoming chlorine or ammonia or positioned as in FIG. 3 or 4, the first flow path section 6 then continues to add diluting water 5 from the reservoir 3 to the second flow path section 8 and into the blending tank 30. Depending upon whether the mixing unit 2 is in disinfecting mode (a) or (b), the respective concentration of chlorine or ammonia is further mixed, blended, and diluted until it is determined desirable to operate the variable speed pump 34 to discharge the blended mixture from the tank 30. It is noted that the venting of the blending tank 30 at 32 to atmosphere helps to achieve this diluting action by allowing the normal level in the mixing tank 30 to rise to accept the increased volume (e.g., an additional 5 gallons to a total of 10 gallons) to accomplish the dilution before the pump 34 is fully engaged to draw out the diluted contents and bring the tank volume back to its normal operating level (e.g., 5 gallons) and flow rate (10-12 gallons per minute) to match the incoming flow rate to the mixing unit 2 from the submerged pump 12 in the reservoir 3 of FIG. 2. It is additionally noted that the bulk storage tanks 20,22 are also vented at 32 to atmosphere.

The feed lines 8′″ and 8″ have the additional advantage in the hard and soft flush modes of FIGS. 3 and 4 that with both the control valves or members 14′ and 14″ positioned to permit the flows as shown in FIGS. 3-4, the control members 14′,14″, side lines 8′,8″, and eductors 26′,26″ are also flushed and cleansed. This then greatly reduces the scaling and corrosion in them as well as in the other parts of the second flow path section 8. It is noted in reference to FIGS. 3-4 that the only lines not so flushed are the chlorine flow line 20′ and ammonia flow line 22″ from the respective tanks 20 and 22 (e.g., holding 55-330 gallons). Consequently, these flow lines 20′,22″ must then be separately monitored and maintained. It is also noted as to the simplicity of the overall design of the mixing unit 2 that the only moving parts are essentially the control valves or members 14,14′, and 14″ (which are preferably of the same design) and the variable speed pump 34. Such simplicity adds greatly to the efficient construction, operation, maintenance, and repair of the mixing unit 2.

The size and volume of the bulk storage units 20,22 can vary as desired as for example from 55 gallons each to 335 gallons. However and in specific regard to the size and volume of the mixing unit 2, it is noted that the size (e.g., 6 feet high by 5 feet wide by 3 feet deep) of the mixing unit 2 without the tanks 20,22 and the volume (e.g., 20-100 gallons or slightly larger) of the mixing unit 2 without the tanks 20,22 in comparison to the size (50-75 feet wide by 30 or more feet high) and volume (e.g., 250,000-10,000,000 gallons) of the reservoir water 5 being treated is quite small and very manageable logistically from a set up and operational standpoint. Also, the bulk storage tanks 20,22 as mentioned can vary greatly in size and volume as desired and are designed as shown as essentially add-on or standalone components next to the fundamental or basic driving components at 4 of the mixing unit 2 in FIG. 2. The fundamental or basic driving components at 4 of the mixing unit 2 can then be used in conjunction with a wide variety of bulk storage tanks 20,22 of chlorine and ammonia as desired.

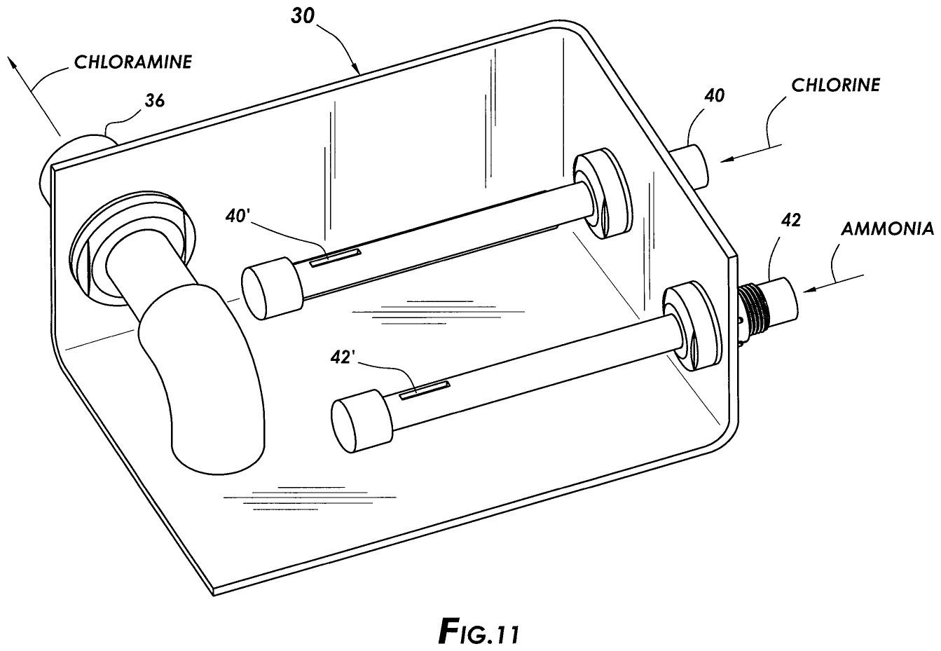

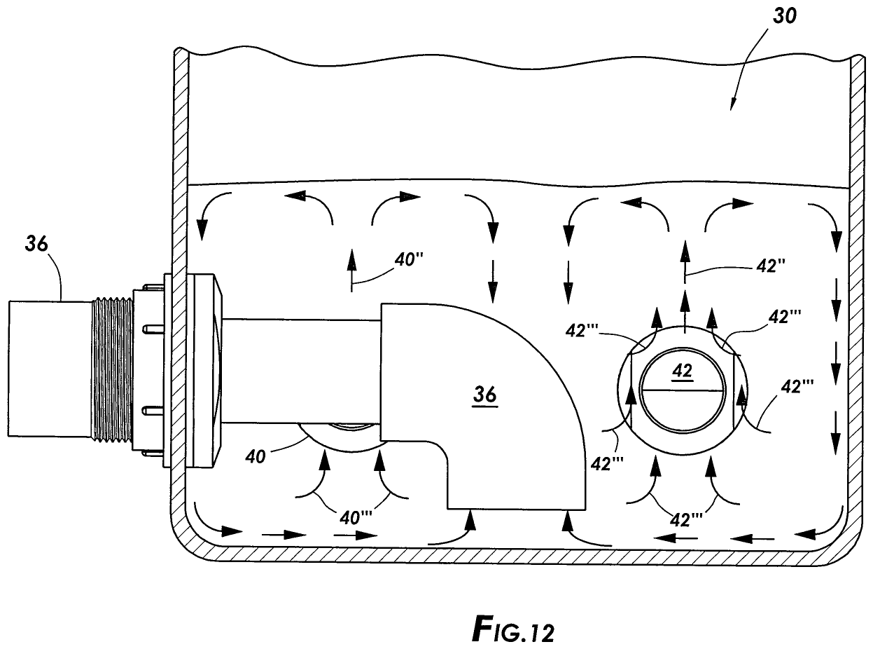

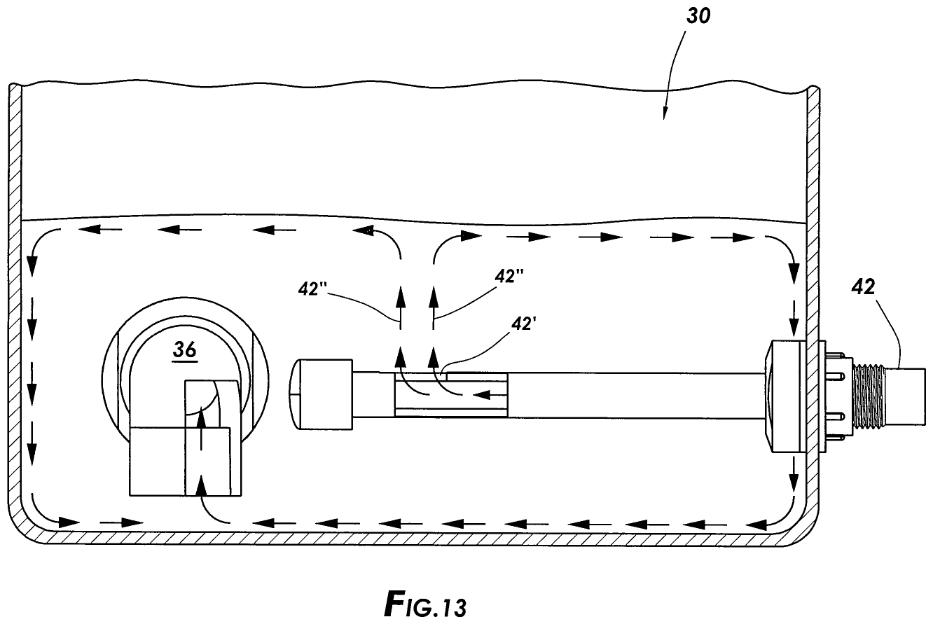

Details of the blending tank 30 of the mixing unit 2 are illustrated in FIGS. 11-13. The blending tank 30 as shown in FIG. 11 has inlet tubes 40 and 42 (see also FIG. 7). When both chlorine and ammonia are being delivered to the blending tank 30 as in FIG. 7, both chlorine and ammonia are received into the tank 30 via the inlet tubes 40 and 42 of FIG. 11. The incoming chlorine and ammonia exit the respective tubes 40,42 upwardly through elongated slots 40′, 42′ (see FIG. 11) that extend axially along the respective tubes 40,42. The exiting chlorine and ammonia from the slots 40′,42′ initially move upwardly at 40″,42″ in FIG. 12 as substantially planar sheet flows. The planar sheet flows 40″,42″ in turn induce upward flows 40′″,42′″ on each side of the respective tubes 40,42 (FIG. 12) and each side of the planar discharging sheet flows 40″,42″. Subsequent end-to-end mixing flows then develop in the blending tank 30 as illustrated in FIG. 13.

The resulting action in this mode (c) thoroughly blends the chlorine and ammonia to form chloramines in the tank 30. As discussed above and once it is determined that the chloramines blend is at a desirable level (e.g., as initially received in the tank 30 or as diluted and blended as discussed above), the variable speed pump 34 in FIG. 7 is run to draw out the blended chloramines through the discharge line 36 from the tank 30 (see also FIGS. 11-13). Eventually as mentioned above, the pump 34 assumes its normal operation to match the incoming flow rate (e.g., 4-5 gallons per minute) to the mixing unit 2 from the submerged pump 12 in the reservoir 3 in FIG. 2. The drawn out chloramines are then completely blended as they leave the tank 30 and are delivered as also mentioned above into the third flow path section 10 of FIG. 7 leading to the main circulator 7 in the water reservoir 3 of FIG. 2. It is noted that the contents of the blending tank 30 in this mode (as well as in all of the other modes) are preferably drawn out of the tank 30 through the discharge line 36 (see FIGS. 12-13) at a location near the bottom of the tank 30 (see FIG. 13) and below the level of the incoming disinfectants discharged upwardly from the inlet tubes 40,42. This helps to ensure as much blending as possible before the withdrawal from the tank 30 although the blending in the tank 30 has been empirically found to be sufficient in most cases due to the sheet flow discharges 40″, 42″ of FIGS. 12-13 that the discharge could be drawn from above the inlet tubes 40,42 if desired.

Referring again to the mode of operation in which (b) only ammonia is being added in FIG. 6, the incoming ammonia to the blending tank 30 through the tube 42 as in FIG. 13 exits through the elongated slot 42′ upwardly to create the substantially planar, upward sheet flow 42″ as in the manner on the right side of FIG. 12. This in turn also creates the end-to-end mixing pattern of FIG. 13 in the blending tank 30. Such operation is then essentially the same as in FIGS. 11-13 except that only ammonia is being added to the tank 30. It is also noted that like in the chloramines mode (c) of FIGS. 11-13, the contents of the blending tank 30 in modes (a)-(b) are drawn out of the tank 30 through the discharge line 36 (see FIGS. 12-13) at a location near the bottom of the tank 30 and below the level of the incoming disinfectants discharged upwardly from the respective inlet tubes 40,42. However, the discharge could be drawn out from above the inlet tubes 40,42 if desired.

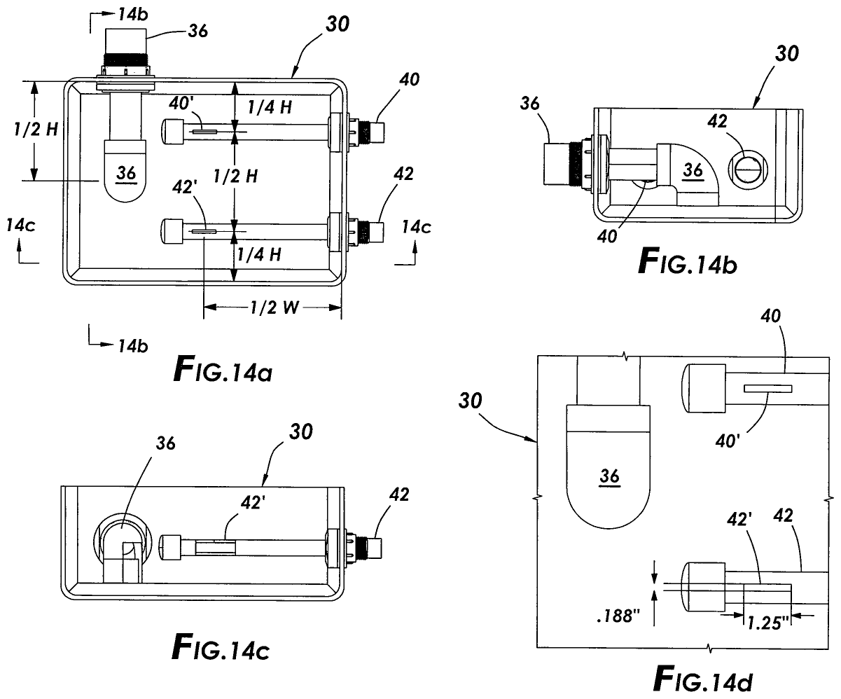

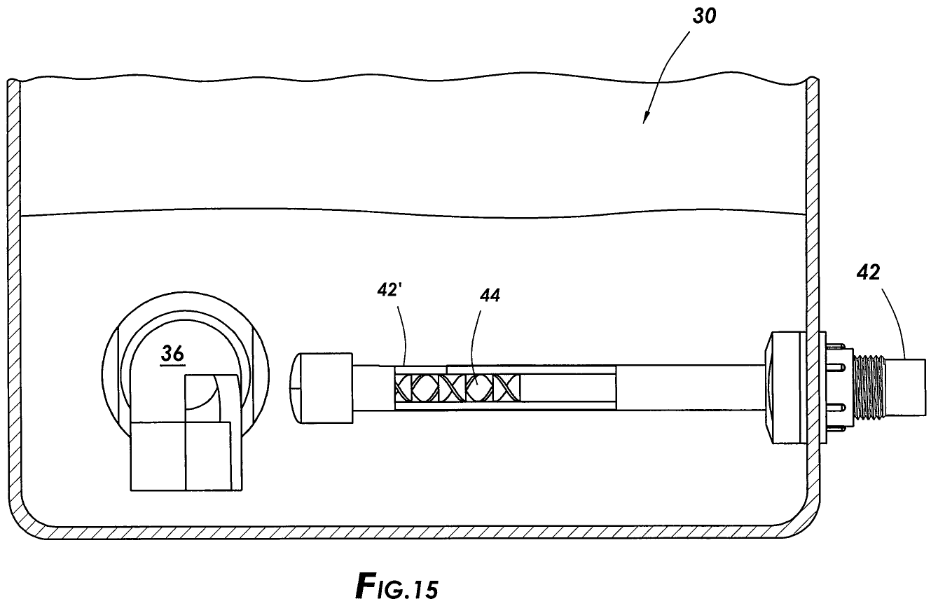

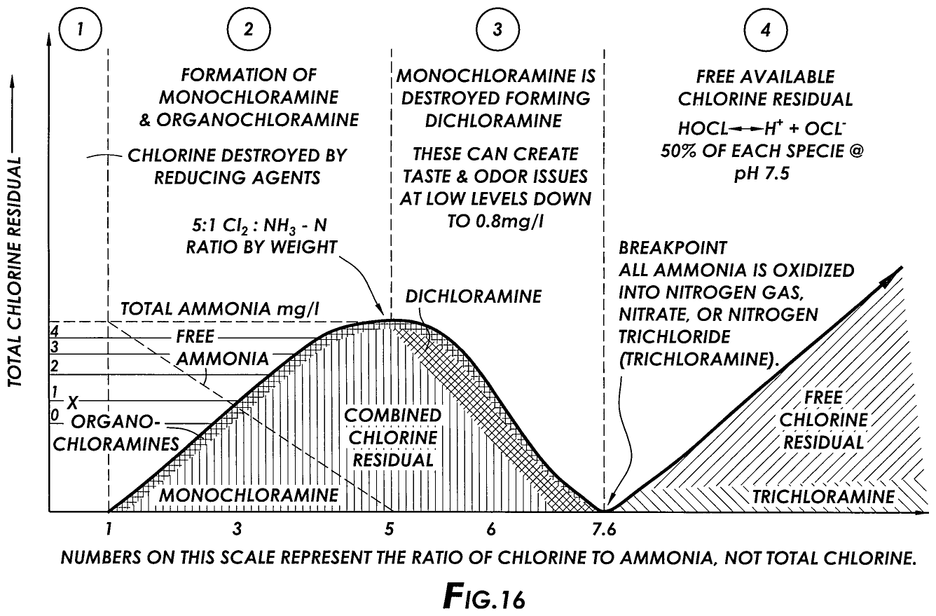

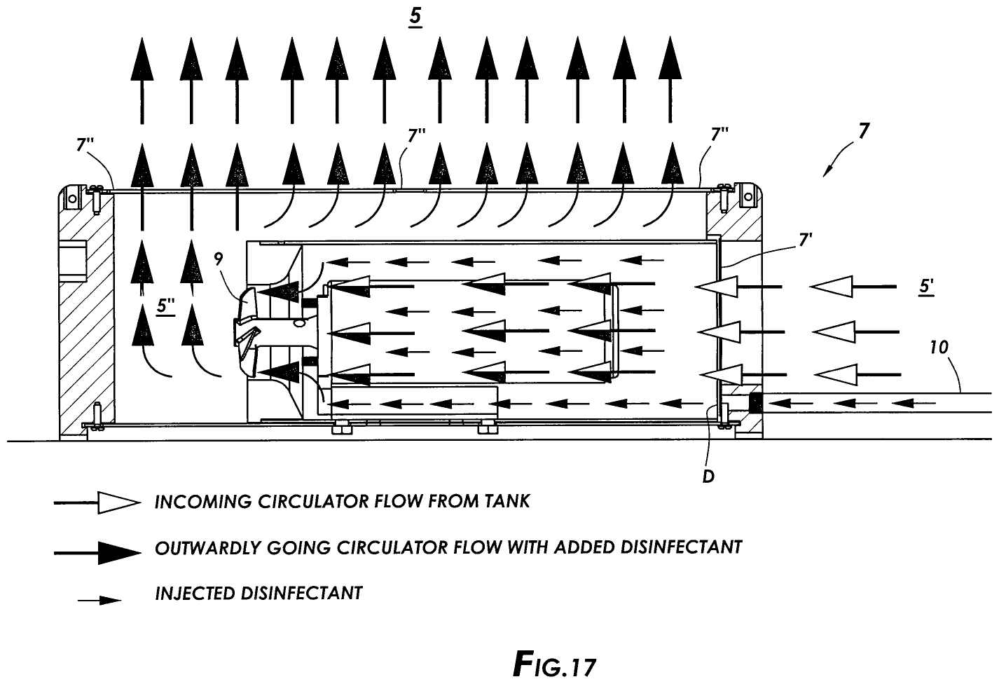

FIGS. 14a-14d are further views of the components of the blending tank 30 including some dimensions for reference purposes. FIG. 15 in turn illustrates the preferred inclusion of a static mixer 44 (e.g., helix) in each of the inlet tubes 40,42 to the tank 30. The static mixers 44 have been found to desirably provide high turbulence to better mix or blend the added chlorine and/or ammonia and to help break up any undesirable clumps or slugs that tend to form, particularly at higher concentrations of added chlorine and/or ammonia. In the chloramines mode of (c), these static mixers 44 have shown to be of significant help in the production of the more desirable monochloramines versus less desirable chloramines such as dichloramines or even trichloramines.

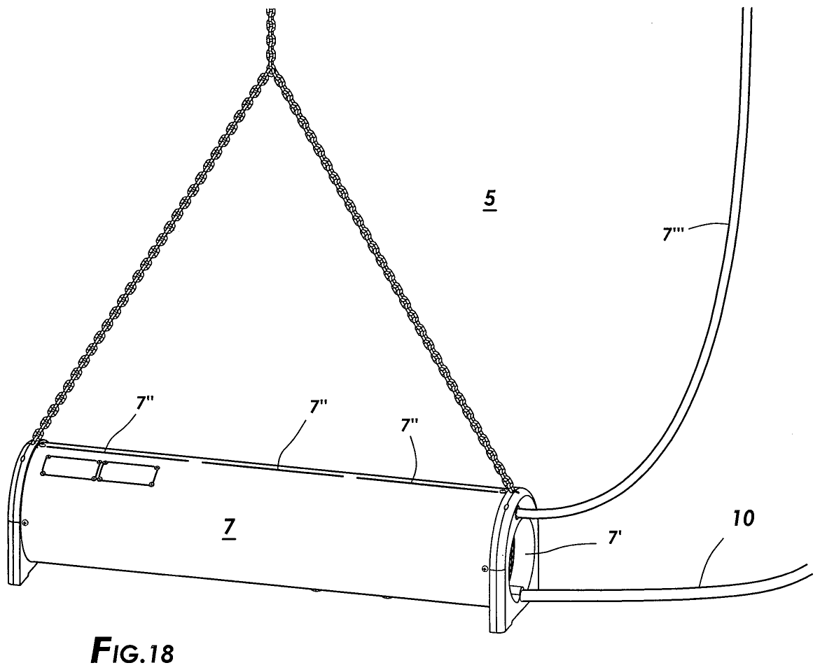

It is emphasized that the preferred operation of the mixing unit 2 is to add disinfectants incrementally in the modes of (a)-(c) in relatively small doses or steps (e.g., 250-500 gallons of blended solution or 1-2 hours depending upon the ‘size of the reservoir 3) and not to overshoot or add too much of any one mode to the reservoir water 5 at any one time, potentially resulting in undesirable conditions in the reservoir water 5. Such undesirable conditions would include too high levels of free chlorine or the creation of dichloramines and even trichloramines. In this regard and as for example, an initial analysis from the analyzers at 4’ that more disinfectant is needed in the reservoir water 5 may be from a low reading of the total chlorine in the water entering the mixing unit 2. However, such a low reading does not precisely indicate where on the curves of FIG. 16 the water 5 in the reservoir 3 is. If it is on the left side of the curve in Section 2 of FIG. 16 and the free chlorine is less than a predetermined percentage of the total chlorine (in free and chloramines form) and in fact free ammonia is available in the reservoir water 5, then the appropriate operating mode is (a) to add more chlorine. This will then desirably form more chloramines in the water 5 in the reservoir 3 in an effort to approach the top of the curve in Section 2.

On the other hand and if the initial low reading of total chlorine is in Section 3 of FIG. 16 and the free chlorine is less than a predetermined percentage of the total chlorine and there is no free ammonia in fact in the water 5 in the reservoir 3, the appropriate operating mode is then (c) to add blended chloramines to the water 5 in the reservoir 3 in an effort to return back up toward the top of the curve in Section 2. In this mode (c) of adding chlorine and ammonia as mentioned above, the preferred manner of operation is actually to blend extra ammonia so that the blend delivered to the reservoir water 5 has chloramines (e.g., 90-95%) and some free ammonia (e.g., 10-5%). The aim is then to return back up the curve in Section 3 toward and beyond the top back into the condition of Section 2 where the chloramines are around 75% up the curve of Section 2 (e.g., 4:1 CL2:NH3-N) and there is some free ammonia in the reservoir water 5. To complete the discussion and if the initial low reading of free chlorine is nearly equal to the total chlorine and the reservoir water 5 is really in Section 4 of FIG. 16, then the system has detected an undesirable reservoir water 5 condition. Ammonia should then be added to the reservoir water 5 to create chloramines in the reservoir 3 but in the preferred manner of operation, the mixing unit 2 is actually shut down until a more detailed analysis and correction plan can be formulated.

To avoid such undesirable overshooting from Section 2 into Section 3 in FIG. 16, the mixing unit 2 of the present invention as mentioned above is preferably operated incrementally in relatively small doses or steps. More specifically and in response to a low total chlorine reading, a small dose (e.g., in time such as 1-2 hours or amount such as 250-500 gallons) of chlorine may be added to the reservoir water 5 with the feedback (e.g., 4 hours later) from the analyzers at 4′ monitored to determine in which section of the curves of FIG. 16 the reservoir water 5 actually is. The appropriate operating mode is then selected by the control arrangement 4 and the appropriate mode is subsequently itself preferably incrementally operated in doses or steps. As for example in the addition of chlorine in Section 2 in an effort to approach (e.g., 70%-80%) the chloramine set point at the peak of the curve in Section 2, it is preferably done incrementally and stopped short (e.g., 75%) so as not to overshoot the peak. Upon further analysis and if a closer position to the peak is desired, additional doses or steps of chlorine perhaps in even smaller amounts can be carefully added if such a closer positioning is desired. In a slightly different manner of operation if the analysis indicates the condition of the reservoir water 5 is in Section 3, the preferred manner of operation is mode (c) with the addition of extra ammonia beyond what is necessary to form just chloramines in an effort to return back up the curve in Section 3 toward and beyond the top back into the condition of Section 2. The chloramines are then preferably at around 75% up the curve of Section 2 and there is some free ammonia (e.g., 0.1-0.2 ppm) in the reservoir water 5 (which is always a desirable condition).

Stated another way and again referring to FIG. 16 and as an overview, the desired residual target is at 4 or about 75% up the slope in Section 2 of FIG. 16. Just below it, point 3 on the slope is the desired residual lag set point or about 65% up the slope. This is the location at which it is desirable to stay prior to trying to take the final step or dose to reach the desired point 4. The halt at point 3 in which no disinfectants are added to the second flow section 8 is taken so that a feedback reading or analysis of the condition of the reservoir water 5 at point 3 can be determined. Such intermittent periods of no additional disinfectants are beneficial since a disinfectant injection or dose moving up the slope in Section 2 may take 2-12 hours or more depending upon the size of the reservoir 3. Consequently, it is best to have a location or threshold like 3 where disinfectant injections are stopped awaiting the feedback so as to minimize any undesirable overshooting up the slope prior to or with the next dosage moving toward location 4 (e.g., 75%). This incremental operation in relatively small doses or steps in moving from point 3 to point 4 (as well as moving in other incremental steps up to point 3 discussed below) is in contrast to other systems that have essentially a single type of action. That is, they pour in chlorine into the reservoir water 5 until they realize it is too much and they have entered Section 3 of FIG. 16. They then fix the problem they knew they would inevitably create by injecting the chlorine and ammonia together into the reservoir water 5 in an effort to return to the peak (i.e., 100%) of the slope in Section 2. This approach of others is essentially doing something (e.g., adding just chlorine) until proven wrong (e.g., too much chlorine is injected and the feedback from the reservoir water 5 shows it has entered Section 3). Trying to be exactly at the peak (versus for example 75%) in the present invention) is also an undesirable goal of others as it tends to just create a yo-yo effect with the residual reservoir water 5 continually moving from Section 2 to Section 3 and back to Section 2 in FIG. 16. In contrast, the preferred operation of the present invention is to always be and stay in the Section 2 of FIG. 16 as near to the peak of the curve as possible.

Returning again to the overview of FIG. 16, point 2 below point 3 on the slope in Section 2 of FIG. 16 is the free ammonia crossover. Most municipalities have normally been operating their reservoirs (such as tank 3 in FIGS. 1-2) for some time before it becomes apparent that a disinfectant mixing unit like 2 is needed. On the positive side, they usually have a good idea where they want the water condition to be and this is normally set and met at the initial, primary disinfectant facility. However, over time or if the tank such as 3 is one in a series of tanks, the desired disinfectant level may be low. For the most part, this is to be expected as the chlorine has been consumed disinfecting the water resulting in there being free ammonia (that was originally combined into chloramines) in the reservoir water 5. Since water usage is typically predictable and follows a usage pattern, the municipalities will know these general levels. For example, water originally treated to 3 ppm may be seen in the tank 3 at 2 ppm. While it cannot be assumed that all of the free ammonia required to go from 2 ppm to 3 ppm is available, the preferred manner of operation of the mixing tank 2 is to try to rebind most of it. This is then the crossover point at 2 on the slope of Section 2 in FIG. 16.

So, when it is realized as discussed above that the residual reservoir water 5 has a low total chlorine reading or threshold such as at point 0 in FIG. 16, the mixing unit 2 is operated to add chlorine only to rebind what is believed to be a safe amount of available free ammonia that is present because some of the original chlorine has been consumed. As for example and in adding just chlorine, 75% of the free ammonia may be used up to get to 2.75 ppm which is essentially at point 1 (free ammonia crossover lag set point) on the slope of Section 2 in FIG. 16. With the free ammonia reduced to a safe level, chloramines are then added to the reservoir water 5 which will actually shift the slope from point 1 and the peak in Section 2 slightly upwardly since the total ammonia dictates how tall the peak is. In any event, the incremental steps or doses up the slope from point 1 to the desired point 4 will deviate slightly to the left in Section 2 of FIG. 16. When the switch to chloramines at point 1 discussed above may be at 3:1 or 3.5:1 Cl2:NH3-N ratio but the chloramines blend may be 4:1 or 4.5:1 so movement will still advance in the x-direction (left to right) along the curve of Section 2 in FIG. 16.

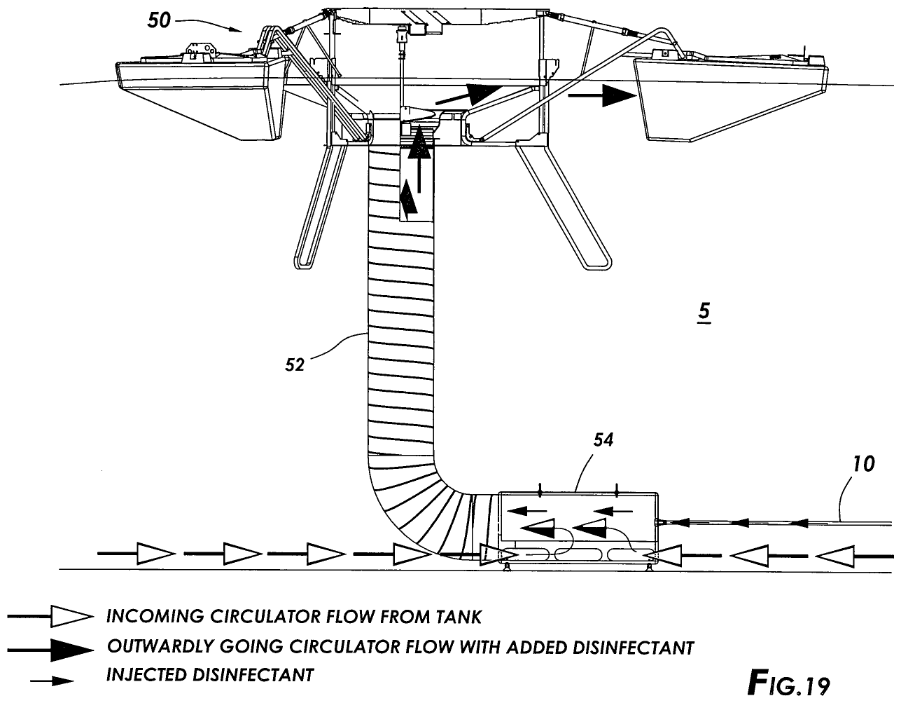

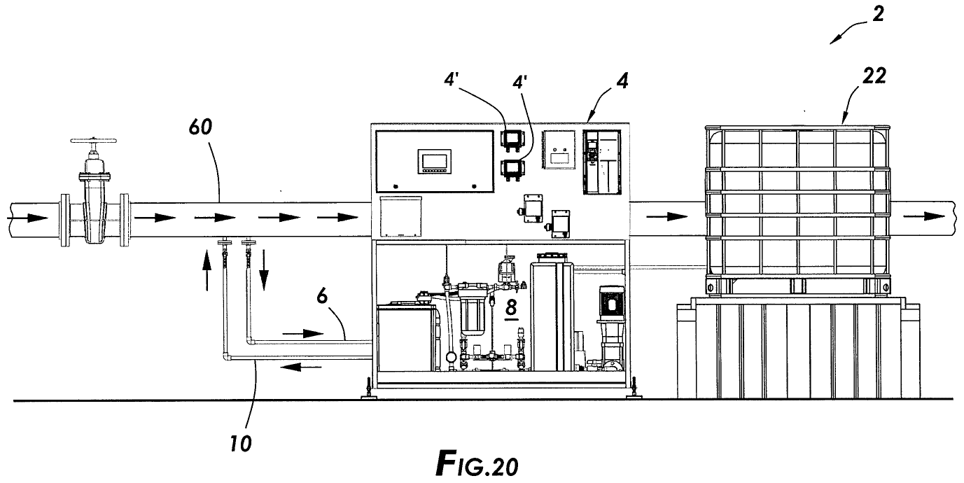

Referring again to FIGS. 2 and 5, the third flow section 10 of the overall water flow path 6,8,10 runs from the discharge of the variable speed pump 34 at location C in FIG. 5 back to the water reservoir 3 in FIG. 2. This section 10 then serves to deliver the blended chemical disinfectant of FIG. 5 (e.g., at 50-70 psi) to the main circulator 7 of the water reservoir 3 at location D in FIG. 2 at a few psi (e.g., 2-5) above that of the circulator 7. In doing so as illustrated in FIG. 17, the incoming chemical disinfectant in the flow path section 10 (illustrated by the small, black arrowheads) enters the circulator 7 at location D essentially at or adjacent where the residual or existing reservoir water 5′ (illustrated by the hollow, large arrowheads) enters the circulator inlet 7′ (see also FIG. 18). The incoming chemical disinfectant then quickly mixes within the circulator 7 in FIG. 17 with the incoming residual reservoir water 5′ and begins to disinfect the incoming residual reservoir water 5′ as illustrated by the half darkened, large arrowheads in FIG. 17. The incoming residual reservoir water 5′ is then thoroughly mixed or blended within the circulator 7 as it flows by the impeller 9 of the circulator 7 (illustrated by the completely darkened, large arrowheads in FIG. 17) after which the fully disinfected water 5″ in the circulator 7 exits through the upwardly facing, axially elongated slots 7″ (see also FIG. 1) as substantially planar, upwardly directed sheet flows that quickly merge into one just above circulator 7. Once the chemical disinfectant mode of FIGS. 5 and 17-18 in our example is completed and the mixing unit 2 cycled through the soft and hard flush modes discussed above, the submerged circulator 7 of FIG. 2 continues to circulate and mix the disinfectant throughout the entire body of the water 5 in the reservoir 3 of FIG. 2. The companion disinfectant modes of FIGS. 6 and 7 are then operated essentially in the same manner.

It is noted at this point that preferably positioning or locating the entire mixing unit 2 and its parts outside of the reservoir 3 (as opposed to physically having all or some within the reservoir 3 and its water 5) is of particular advantage in setting up, monitoring, and maintaining the mixing unit 2 and its parts. As an overview and except for the main circulator 7 and submersible pump 12 in FIGS. 1-2, all of the components of the water treatment system 1 of the present invention are located or positioned entirely outside of the reservoir 3 and its water 5. Further, even the components 7 and 12 of the water treatment system 1 positioned within the reservoir 3 are easily and quickly removable with their flexible lines or hoses 6 and 10 as well as their power cords 7′″ and 12′ from the reservoir 3 through the opened hatch 3′ of FIG. 1 without having to have any personnel physically enter the reservoir 3. This offers a great safety advantage to the operators and adds significantly to the speed and efficiency with which the water treatment system 1 of the present invention can be employed.

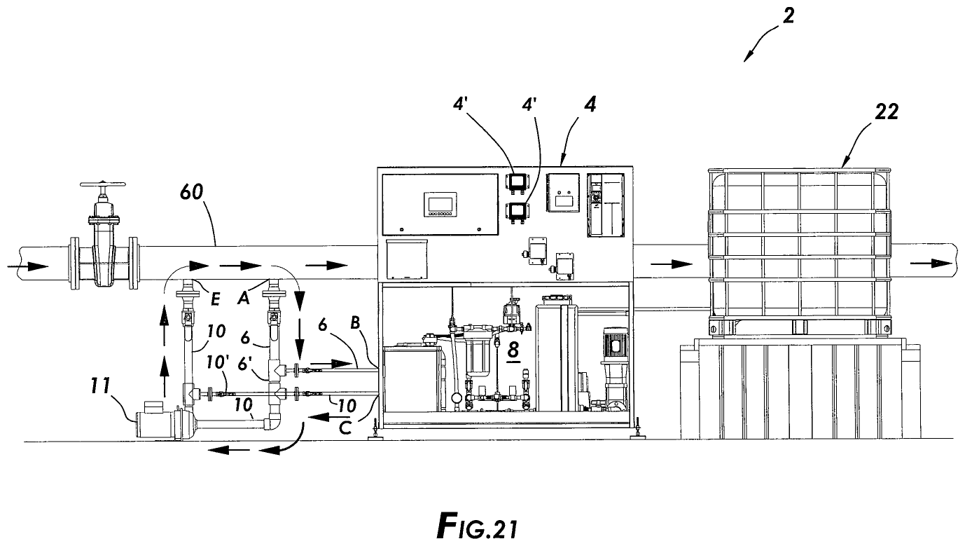

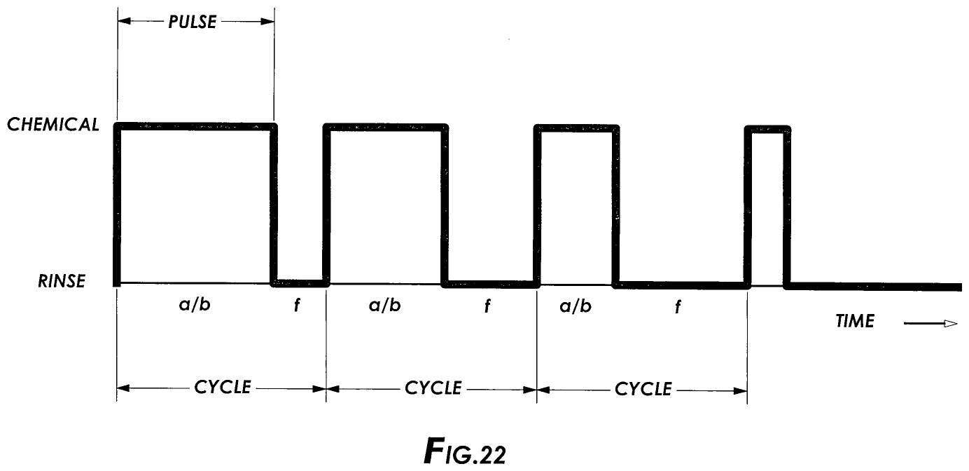

FIGS. 19-21 illustrate other environments in which the basic operation of the mixing unit 2 can be used. In FIG. 19, the water treatment system of the present invention is shown in use in the environment of a floating circulator 50 with a descending draft tube 52 and inlet 54 resting on the bottom of a reservoir such as might be used in a municipal water tank 3 as in FIGS. 1-2 or in an open water reservoir such as a pond or lake. In FIGS. 20-21, the basic design of the mixing unit 2 of the present invention is shown in use operating in an environment in which the water reservoir to be treated is a pipeline 60 of flowing water adjacent the mixing unit 2. In the pipeline embodiment of FIGS. 20-21, additional feedback of the water condition as analyzed downstream of the mixing unit 2 or even from any downstream reservoir (e.g., municipal water tank or open reservoir) into which the pipeline 60 empties may be incorporated into the operation of the mixing unit 2 of FIG. 20 if desired.

In the embodiment of FIG. 21, the first path section 6 has a portion 6′ that bypasses the mixing unit 2 and flows directly into the third path section 10 flowing back into the water in the pipeline 60. An auxiliary pump 11 is then provided in the third path section 10 in FIG. 21 to increase the volume and flow rate of water drawn into the first path section 6 at A and into the portion 6′ bypassing the mixing unit 2 and flowing directly into the third path section 10 and back into the pipeline 60 at E. The inclusion of the auxiliary pump 11 offers the advantages of more thoroughly mixing and diluting the discharge from C of the mixing unit 2 in FIG. 21 into the third path section 10 and to create more turbulence and mixing in the pipeline 60 at the discharge E of the third path section 10 back into the pipeline 60. The embodiment of FIG. 21 with its auxiliary pump 11 has particular uses in areas of large pipelines that require large and more forceful volumes of disinfectant injection for proper mixing in the pipeline as well as in low flow portions of pipelines that often lack the velocity to effectively blend the disinfectant injected into the pipeline. This last situation can lead to hot spots or slugs of concentrated disinfectants undesirably reaching nearby homes and businesses downstream on the pipeline 60. By using the auxiliary pump 11 in such situations, a highly turbulent area is produced adjacent the discharge location E in FIG. 21 ensuring the disinfectant is thoroughly blended into the pipeline 60. Other methods such as static mixers and plumbing (e.g., pipe size reduction) are available to increase mixing and flow rates but they still require some velocity to achieve mixture (e.g., typically greater than 1 ft/sec), which is not always available. Static mixers and additional plumbing are also typically installed in series, which can potentially cause problems with blockages or restrictions during high demand situations downstream (e.g., during emergencies such as fires).

Referring again to FIG. 21 and to avoid the need to provide an expensive pump 11 (e.g., titanium construction) in environments that very strong disinfectant concentrations are discharged at C from the mixing unit 2, a bypass section 10′ in FIG. 21 can be provided to direct the discharge into the third path section 10 from the mixing unit 2 to a location downstream of the auxiliary pump 11. The flow from the bypass section 6′ in such a configuration would still pass directly through the third flow section 10 to the auxiliary pump 11 but the concentrated disinfectant would then be safely added to the third flow section 10 downstream of the auxiliary pump 11 to be discharged at E into the pipeline 60.

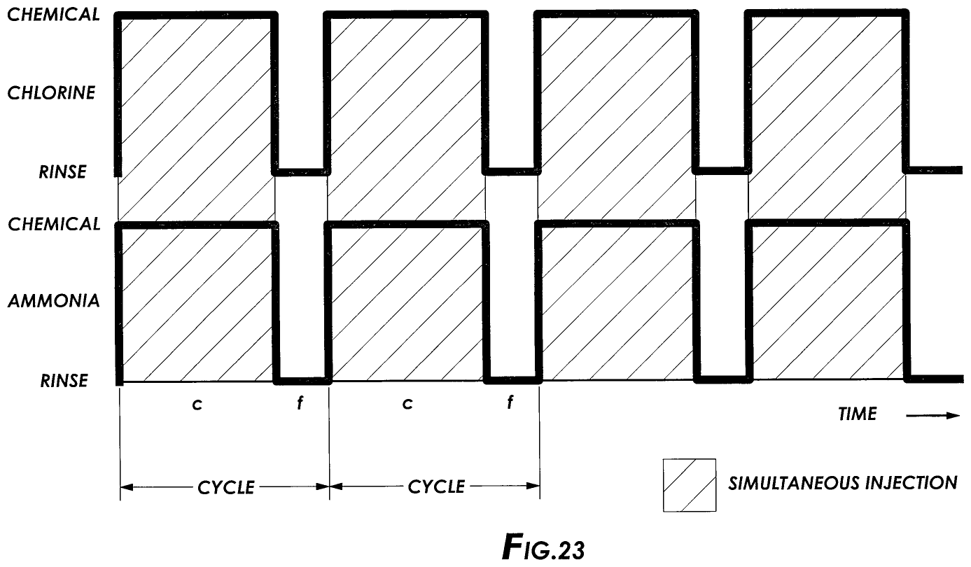

As illustrated in FIGS. 22-26 and as previously discussed, the control arrangement 4 of the mixing unit can be selectively operated to run the mixing unit 2 and its components in a wide variety of manners or schemes to meet the desired needs for treatment of the water 5 in the reservoir 3 of FIGS. 1-2 and pipeline 60 of FIGS. 20-21. This includes selectively varying the order of operation of modes (a)-(c) as well as the hard and soft flushes or rinses, the length of time of operation of each of the modes (a)-(c) and hard and soft flushes, and the length of time between each of these operations. These can be accomplished in a number of ways as previously mentioned (e.g., by throttling the suction ports 8′,8″ of the eductors 26′,26″ to control the volume they pull such as by needle valves or smaller diameter tubing or by regulating the pressure seen at the inlet to the eductors 26′,26″ as well as by adding static mixers or otherwise increasing the discharge pressure to alter the performance of the eductors 26′,26″). However, the preferred way of doing so including controlling the flow rates, flow ratios, and disinfectant mixing is by electronically controlling the flow valves or members 14,14′,14″ by pulse width modulation (PWM) schemes. With such schemes, the desirable manners of operation of the mixing unit 2 including those illustrated in FIGS. 22-26 can be efficiently and accurately accomplished with the manipulation of a relatively small number of parts or components of the mixing unit 2.

More specifically and referring first to FIG. 22, the pulse or insertion time, rate, and volume of each individual chemical (e.g., only chlorine in mode (a) or only ammonia in mode (b) represented as a/b in FIG. 22) and any flush or cleansing rinse mode at f in FIG. 22 between the pulses can be selected and varied as desired. As indicated in FIG. 22, the x axis is time and each vertical line is a cycle or period. During an individual disinfectant feed of chlorine in mode (a) or ammonia in mode (b), the respective flow control valve 14′,14″ is actuated at the beginning on the left side of FIG. 22 from selecting or allowing a flush or cleansing “Rinse” (as discussed in regard to FIG. 10) to selecting “Chemical” (e.g., chlorine as discussed in regard to FIG. 8). This switch is also represented by changing from the flow configuration depicted in FIG. 4 (“Soft Flush”) to that of FIG. 5 or 6 (individual disinfectant feeds). The duration of this selection or operation then determines how much individual disinfectant is fed which could be for the entire cycle or any portion(s) of it as in FIG. 22 with cleansing rinses or flushes f preferably in between. For example, if the pulse is only on for half of the cycle, it would be at 50% input. If the chemical flows through the respective educator 26′,26″ at 2.5 gallons/hour, the resulting flow rate averaged over time would then be 1.25 gallons/hour. In such a way, the flow rates and ratios can then be efficiently and accurately controlled electronically by the PWM of the control arrangement 4. Cycle times could vary but it is a period of 30 seconds for this discussion.

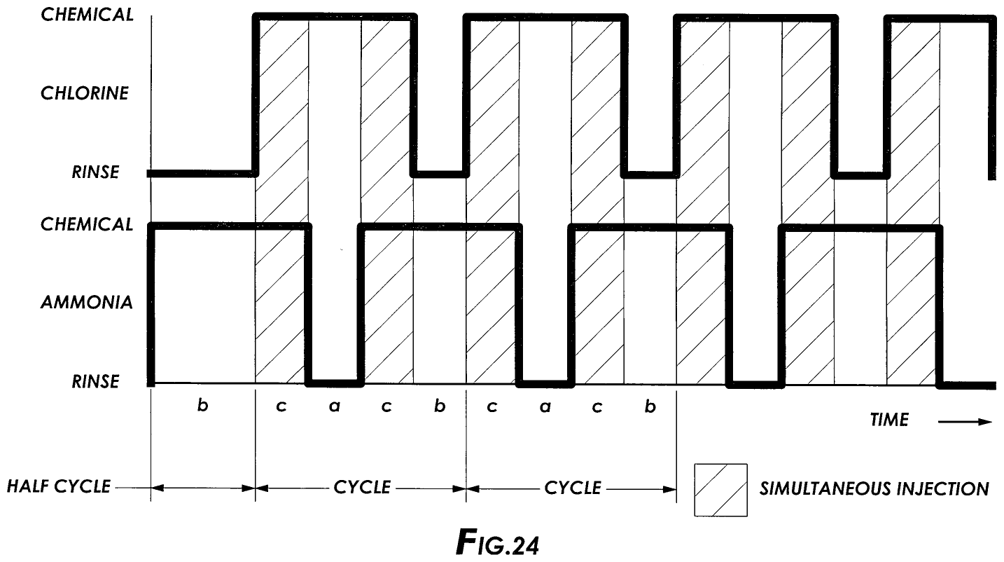

FIG. 23 illustrates the operation of the PWM of the control arrangement 4 to allow dual injection of the chlorine and ammonia in mode (c). As previously discussed, the duration of each pulse of individual disinfectant may be electronically varied to achieve differing flow rates but in the case of FIG. 23, each chemical is in phase meaning they are turned on and off together or simultaneously as indicated by the crosshatching in FIG. 23. Although the electronic PWM scheme is preferred for efficiency and accuracy, it is again noted that the operation depicted in FIG. 23 including the chemical magnitude (y axis) could be varied and controlled mechanically if desired through a regulator or other mechanical means.

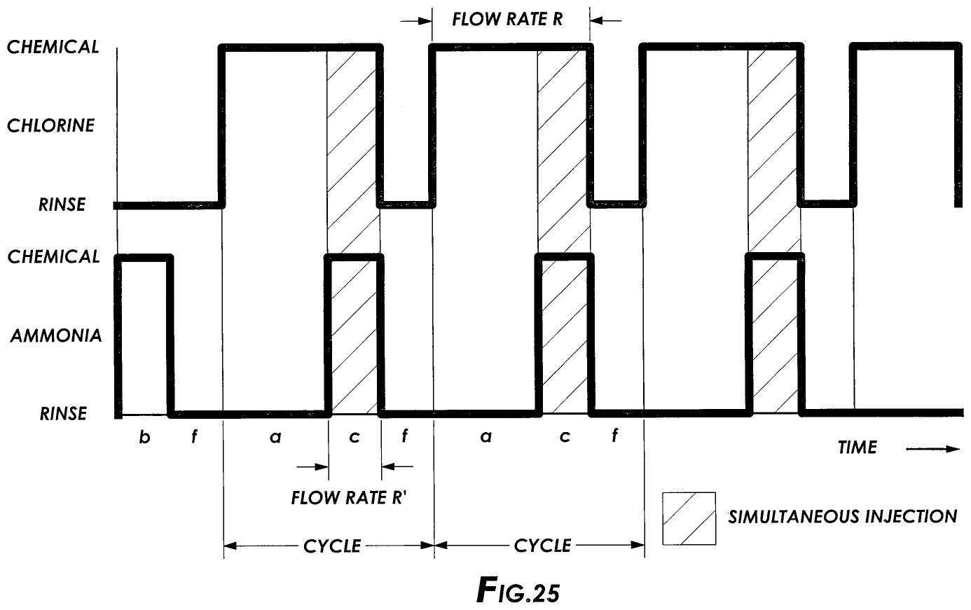

FIG. 24 depicts a particularly desirable operation or scheme in which the individual disinfectant feeds are offset (e.g., by a half cycle or any fraction thereof). This gives each of the respective disinfectants time to further dilute in the blending tank 30 and limits the time the mixing tank 30 is exposed to concentrated disinfectant, particularly chlorine which can be quite corrosive to the blending tank 30 and its components. An added benefit of this scheme is that the order of injection can be controlled to achieve certain desirable results. For example and in the case of chlorine and ammonia injections with the intention of forming chloramines in mode (c), it is highly desirable to lead the operation with an ammonia mode (b) injection (see b on the left side of FIG. 24). In this manner, a guaranteed free ammonia residual in a sufficient amount (which can be empirically determined) will be available to combine with the chlorine once it is subsequently injected either simultaneously in mode (c) (see the first c in FIG. 24) or individually at a in FIG. 24 and still have fee ammonia remaining. That is, with the mixing unit 2 in a flush or cleansing rinse mode just before the start of FIG. 24, an initial injection of ammonia in mode (b) is operated (e.g., for a half cycle) at the initial b in FIG. 24. This will put an extra or sufficient amount of ammonia into the blending tank 30 that carries throughout the rest of the scheme of FIG. 24 and guarantees that any subsequent injection of chlorine in either mode (a) or (c) into the blending tank 30 will be into a free ammonia rich environment or residual. This is particularly important when chloramine formation is involved as introducing chlorine into an existing chloramine mixture without sufficient free ammonia residual present can undesirably destroy all or a portion of the existing and newly formed chloramines.

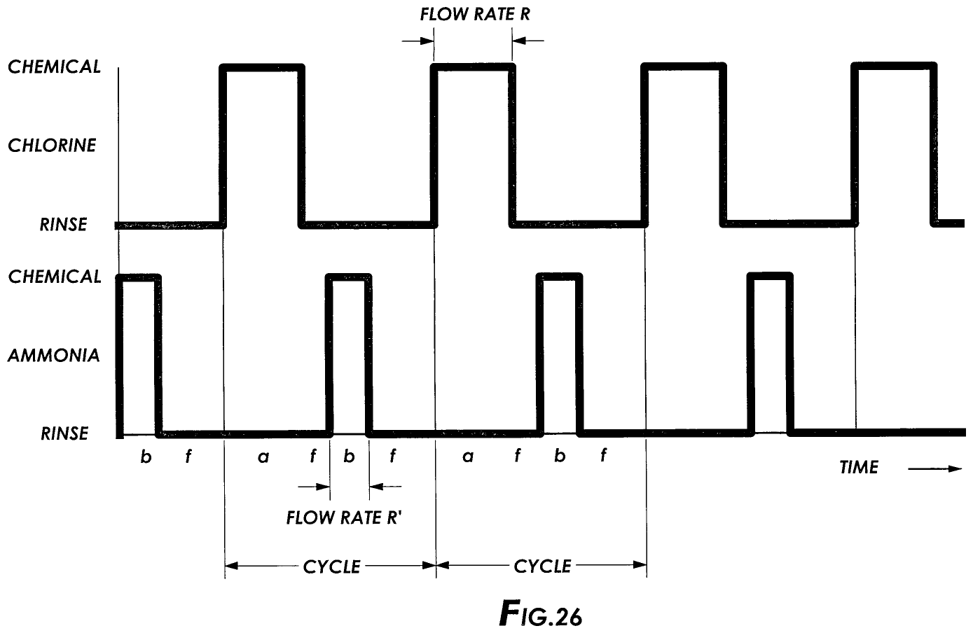

The schemes of FIGS. 25-26 incorporate the advantage of leading with an ammonia injection in mode (b) when the subsequent intention is to form chloramines in the blending tank 30 and offer additional advantages. In FIG. 25 and in the situation where differing flow rates of chlorine and ammonia are needed to meet various concentration ratios of chlorine and ammonia dictated by industry or community standards, the mixing unit 2 can be operated accordingly. For example and in the case of 12.5% sodium hypochlorite (12% available Cl2) and 35% liquid ammonium sulfate (7.35% available N) with a feed ratio of 4.5:1 Cl2:NH3-N, the flow rate R in FIG. 25 would be approximately 2.75 times that of the flow rate R′. This example keeps the feed ratio below 5:1 that would leave no extra ammonia and the flow rates R, R′ in this example can then minimize the length of the less desirable simultaneous injection of mode (c) by allowing for additional mixing or dilution of the respective individual chemical in the blending tank 30 prior to the injection of the other one. In a related manner when the system 1 has significant feed rate capabilities beyond the needs of the reservoir 3 of FIGS. 1-2, the individual chemical injections can be only a fraction of a cycle as in FIG. 26. In the flow rate ratio of 2.75:1 discussed above, this may permit the chemical or disinfectant injections to then be completely offset or separated. Consequently, there may be no need for any simultaneous chemical injections into the blending tank 30, allowing the individual disinfectants to be thoroughly mixed or diluted in the blending tank 30 at the desired, precise ratio without any simultaneous operation in the mode (c). It is noted as illustrated in FIGS. 25-26 that regardless of the chemical operations and offsets, the cleansing rinses or flushes at f are still preferably included in each cycle. In most cases, the illustrated flushes f would preferably be soft ones with hard ones then preceding and following the full operations of the illustrated schemes.

It is noted here that the basic treatment system of the present invention is also applicable to non-potable water reservoirs that mostly involve the addition of primarily chlorine such as in wastewater systems, pipelines, and food processing wash down systems as well as other potable and non-potable water systems that use disinfectants other than chlorine, ammonia, and chloramines. In such applications that may involve just a single disinfectant (e.g., chlorine), the hard and soft flushes would still be desirable.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims. In particular, it is noted that the word substantially is utilized herein to represent the inherent degree of uncertainty that may be attributed to any quantitative comparison, value, measurement or other representation. This term is also utilized herein to represent the degree by which a quantitative representation may vary from a stated reference without resulting in a change in the basic function of the subject matter involved.

We claim:

1. A water treatment system (1) for a reservoir (3) of water (5) including a mixing unit (2) located outside of the reservoir and in a flow path of water (6,8,10) having at least first, second, and third path sections, said first path section (6) flowing from the water in said reservoir to said mixing unit, said second path section (8) flowing through the mixing unit, and said third path section (10) flowing back into the water in the reservoir from the mixing unit,
said mixing unit (2) having a first bulk storage tank (20) of chlorine and a second bulk storage tank (22) of ammonia and a control arrangement (4) to selectively operate the mixing unit in at least three modes wherein (a) chlorine is added from the first bulk storage tank (20) in a first mode to the flow in said second path section (8) of the water flow path while ammonia is prevented from being added from the second bulk storage tank to said second path section, (b) ammonia is added from the second bulk storage tank (22) in a second mode to the flow in said second path section (8) of the water flow path while chorine is prevented from being added from the first bulk storage tank to the flow in said second path section, and (c) both chlorine from the first bulk storage tank (20) and ammonia from the second bulk storage tank (22) are added in a third mode to the flow in said second path section (8) of the water flow path to form chloramines in the second path section, the flow in said second path section (8) in each respective mode flowing from the mixing unit (2) on through the third path section (10) of the water flow path back to the water (5) in said reservoir (3).

2. The water treatment system of claim 1 further including a chlorine flow line (20′) from said first bulk storage tank (20) of chlorine to said second path section (8) flowing through the mixing unit and an ammonia flow line (22″) from the second bulk storage tank (22) to said second path section (8) flowing through the mixing unit, said mixing unit further including a chlorine flow control member (14′) between the chlorine flow line (20′) and the second path section (8) and an ammonia flow control member (14″) between the ammonia flow line (22″) and the second path section (8) wherein said respective control members (14′,14″) are positionable to permit and prevent flows through the respective chlorine and ammonia flow lines (20′,22″) into the second path section (8) of the water flow path.

3. The water treatment system of claim 2 wherein said chlorine flow control member (14′) is positionable to permit flow through the chlorine flow line (20′) to add chlorine in the first mode (a) from the first bulk storage tank (20) to the second path section (8) with the ammonia flow control member (14″) positioned to prevent the flow through the ammonia flow line (22″) from the second bulk storage tank (22) to the second path section (8).

4. The water treatment system of claim 2 wherein said ammonia flow control member (14″) is positionable to permit flow through the ammonia flow line (22″) to add ammonia in the second mode (b) from the second bulk storage tank (22) to the second path section (8) with the chlorine flow control member (14′) positioned to prevent the flow through the chlorine flow line (20′) from the first bulk storage tank (20) to the second path section (8).

5. The water treatment system of claim 2 wherein the respective chlorine and ammonia flow control members (14′,14″) are positionable to permit the respective flows of chlorine from the first bulk storage tank and ammonia from the second bulk storage tank in the third mode (c) to add both chlorine and ammonia to the second path section (8) to form chloramines.

6. The water treatment system of claim 5 wherein said mixing unit includes a blending tank (30) in said second path section (8) to receive the added chlorine and ammonia in the third mode (c) wherein the chloramines are formed in the blending tank.

7. The water treatment system of claim 6 further including a main flow control member (14) in the second path section (8) of the respective chlorine and ammonia flow control members (14′,14″) and in fluid communication by respective feed lines (8′″,8″″) with the respective chlorine and ammonia flow control members (14′,14″).

8. The water treatment system of claim 7 wherein the chlorine and ammonia flow control members (14′,14″) are respectively positionable to permit and prevent the respective flows from the main flow control member (14) through the respective feed lines (8′″,8″″) of the second path section (8).

9. The water treatment system of claim 7 wherein the water in the first path section (6) from the reservoir (3) is hard water containing calcium and the mixing unit further includes a water softener arrangement (16) in the second path section (8) to remove calcium from the hard water from the first path section (6) wherein the water from the reservoir is softened and the control arrangement (4) of the mixing unit (2) is operable in a mode to flush at least a portion of the second path section (8) including the main flow control member (14) and the respective chlorine and ammonia flow control members (14′,14″) with softened water.

10. The water treatment system of claim 2 wherein the mixing unit further includes a blending tank (30) in the second path section (8) to selectively receive the added chlorine of the first mode (a), the added ammonia of the second mode (b), and the added chlorine and ammonia of the third mode (c) to form chloramines in the blending tank.

11. The water treatment system of claim 10 wherein the chlorine flow control member (14′) is positionable to permit flow through the chlorine flow line (20′) to add the chlorine in the first mode (a) from the first bulk storage tank (20) to the second path section (8) and into the blending tank (30) thereof with the ammonia flow control member (14″) to prevent the flow of ammonia from the second bulk storage tank (22) to the second path section (8).

12. The water treatment system of claim 10 wherein the ammonia flow control member (14″) is positionable to permit flow through the ammonia flow line (22″) to add the ammonia in the second mode (b) from the second bulk storage tank (22) to the second path section (8) with the chlorine flow control member (14′) positioned to prevent the flow of chlorine from the first bulk storage tank (20) to the second path section (8).

13. The water treatment system of claim 10 wherein the control arrangement (4) for the mixing unit (2) is further selectively operable in a fourth mode (d) wherein the chlorine and ammonia flow control members (14′,14″) are positionable to prevent the respective flows of chlorine and ammonia from the respective first and second bulk storage tanks (20,22) into the second path section (8) wherein the water from the reservoir in the first path section (6) flows into the second path section (8) and through the mixing unit (2) of the second path section (8) and back to the water (5) in the reservoir (3) from the mixing unit through the third path section (10) to flush at least a portion of the second path section (8) including the main flow control member (14) and the respective chlorine and ammonia flow control members (14′,14″).

14. The water treatment system of claim 13 wherein the control arrangement (4) selectively operates the mixing unit in the fourth mode (d) before and after each of the respective three modes (a)-(c) and any combinations thereof.

15. The water treatment system of claim 13 wherein the mixing unit further includes a water softener arrangement (16) in the second path section (8) to remove calcium from the hard water from the first path section (6) wherein the water (5) from the reservoir (3) is softened and the control arrangement (4) of the mixing unit is operable in a fifth mode (e) to flush at least a portion of the second path section (8) including the main flow control member (14) and the respective chlorine and ammonia flow control members (14′,14″) with softened water.

16. The water treatment system of claim 15 wherein the control arrangement (4) selectively operates the mixing unit in the fifth mode (e) to flush the second path section (8) through the mixing unit with softened water after the fourth mode (d) to flush the second path section with hard water and before and after at least one of the three modes (a)-(c) and any combinations thereof.

17. The water treatment system of claim 16 wherein the control arrangement (4) selectively operates the mixing unit in the fourth mode (d) to flush the second path section (8) with hard water after the control arrangement (4) has operated the mixing unit in the fifth mode (e) to flush the second path section (8) with softened water.

18. The water treatment system of claim 2 wherein the water (5) in the first path section (6) from the reservoir (3) is hard water containing calcium and the mixing unit further includes a water softener arrangement (16) in the second path section (8) to remove calcium from the hard water from the first path section (6) wherein the water from the reservoir is softened and the control arrangement (4) of the mixing unit (2) is operable in a mode to flush at least a portion of the second path section (8) with softened water.

19. The water treatment system of claim 18 wherein the water softener arrangement (16) is located upstream in the second flow path section (8) of where the chlorine and ammonia are added to the second flow path section (8) wherein the chlorine and ammonia added to the second path section (8) in the respective modes (a)-(b) are added to softened water.

20. The water treatment system of claim 18 wherein the main flow control member (14) is selectively operable to permit and prevent flow from the first path section (6) into the water softener arrangement (16).

21. The water treatment system of claim 1 wherein the mixing unit (2) includes a blending tank (30) in the second path section (8) to selectively receive the added chlorine of the first mode (a), the added ammonia of the second mode (b), and the added chlorine and ammonia of the third mode (c) to form chloramines in the blending tank.

22. The water treatment system of claim 21 wherein the blending tank (30) is selectively operable to permit and restrict discharge therefrom toward the third path section (10), said blending tank in the position of restricting discharge allowing water from the first path section (6) to continue to flow into the second path section (8) to dilute the concentration in the second path section including the blending tank of chlorine, ammonia, or chlorine and ammonia depending upon which of the three modes (a)-(c) and combinations thereof the control arrangement (4) is operating the mixing unit.

23. The water treatment system of claim 22 wherein at least one of the blending tank (30), the first bulk storage tank (2), and the second bulk storage tank (22) is vented to atmosphere.

24. The water treatment system of claim 23 wherein each of the blending tank (30) and the first and second bulk storage tanks (20,22) is vented to atmosphere

25. The water treatment system of claim 23 wherein the mixing unit (2) further includes a pump (34) selectively operable to withdraw the chlorine, ammonia, or chloramines from the blending tank depending upon which of the three modes (a)-(c) and combinations thereof the control arrangement (4) is operating the mixing unit and to deliver same into the third path section (10) leading back to the water (5) in the reservoir (3).

26. The water treatment system of claim 25 wherein the pump (34) is a variable speed pump.

27. The water treatment system of claim 1 wherein the control arrangement (4) for the mixing unit (2) includes at least one analyzer (4′) to determine at least one of the free chlorine and total chlorine in the water (5) from the reservoir (3) in the first path section (6).

28. The water treatment system of claim 1 wherein the modes of (a)-(c) are incrementally operated to respectively add the chlorine of (a), the ammonia of (b), and the blended chlorine and ammonia forming chloramines of (c) in a series of doses to the second flow section (8) and on through the third flow section (10) to the reservoir water (5).

29. The water treatment system of claim 1 wherein the control arrangement (4) for the mixing unit includes at least one analyzer (4′) to repeatedly determine at least one of the free chlorine and total chlorine in the water (5) from the reservoir (3) in the first path section (6) and to feedback the repeated determinations to the control arrangement (4) and wherein the modes of (a)-(c) are incrementally operated to respectively add the chlorine of (a), the ammonia of (b), and the blended chlorine and ammonia forming chloramines of (c) in a series of doses to the second flow section (8) and on through the third flow section (10) to the reservoir water (5) based on the feedback of the repeated determinations of the analyzer to the control arrangement.

30. The water treatment system of claim 1 wherein the modes of (a)-(c) are incrementally operated to respectively add the chlorine of (a), the ammonia of (b), and the blended chlorine and ammonia forming chloramines of (c) in a series of doses with intermittent periods of adding no disinfectants between the doses.

31. The water treatment system of claim 1 wherein the water in the reservoir is hard water containing calcium and the control arrangement (4) selectively operates the mixing unit in a fourth mode (d) before and after the respective three modes (a)-(c) and any combinations thereof to flush at least a portion of the second path section (8) with hard water from the reservoir and wherein the control arrangement runs the flush with hard water from the reservoir continually until a subsequent mode of at least one of (a)-(c) is initiated.

32. The water treatment system of claim 1 further including a circulator (7) positioned in the water (5) in the reservoir (3) to circulate the water in the reservoir, said circulator (7) having an inlet (7′) and outlet (7″) and said third path section (10) discharging into the circulator between the inlet and outlet of the circulator.

33. The water treatment system of claim 32 wherein the reservoir (3) has a bottom and the circulator (7) is positioned on the bottom.

34. The water treatment system of claim 1 wherein the reservoir is at least one of an enclosed tank, a reservoir open to atmosphere, and a pipeline.

35. The water treatment system of claim 1 wherein the control arrangement (4) selectively varies the order of operation of modes (a)-(c), the length of time of operation of each of the modes (a)-(c), and the length of time between each operation of modes (a)-(c).

36. The water treatment system of claim 1 wherein the control arrangement (4) selectively varies at least two of the order of operation of modes (a)-(c), the length of time of operation of each of the modes (a)-(c), and the length of time between each operation of modes (a)-(c).

37. The water treatment system of claim 1 wherein the control arrangement (4) selectively varies at least one of the order of operation of modes (a)-(c), the length of time of operation of each of the modes (a)-(c), and the length of time between each operation of modes (a)-(c).

38. The water treatment system of claim 1 wherein the mixing unit (2) includes a blending tank (30) in said second path section (8) to receive the added chlorine in mode (a) and added chlorine and ammonia in mode (c) wherein the chloramines are formed in the blending tank in mode (c) and wherein the control arrangement (4) operates the mixing unit in mode (b) to add ammonia to the blending tank in a sufficient amount prior to mode (a) or (c) to provide a free ammonia rich residual in the blending tank into which the subsequent chlorine of mode (a) or (c) is received to facilitate the formation of the chloramines in the blending tank.

39. The water treatment system of claim 1 wherein the reservoir is a pipeline (60) and the first path section (6) has a portion (6′) that bypasses the mixing unit and flows directly into the third path section (10) flowing back into the water in the pipeline.

40. The water treatment system of claim 39 wherein the third path section (10) has a pump (11) therein to increase the volume and flow rate of water into the portion (6′) of the first path section (6) bypassing the mixing unit (2) and flowing directly into the third path section (10) back into the pipeline to more thoroughly mix and dilute the discharge from the mixing unit into the third path section (10) and to create more turbulence in the pipeline at the discharge (E) of the third path section (10) back into the pipeline (60).

41. A water treatment system (1) for a reservoir (3) of water (5) including a mixing unit (2) located in a flow path of water (6,8,10) having at least first, second, and third path sections, said first path section (6) flowing from the water in said reservoir to said mixing unit, said second path section (8) flowing through the mixing unit, and said third path section (10) flowing back into the water in the reservoir from the mixing unit,
said mixing unit (2) having at least a first bulk storage tank (20) of disinfectant and a disinfectant flow line (20′) from the first bulk storage tank (20) of disinfectant to said second path section (8) flowing through the mixing unit with a disinfectant flow control member (14′) positioned between the disinfectant flow line (20′) and the second path section (8), said mixing unit further including a control arrangement (4) to selectively operate the mixing unit in at least two modes wherein (i) disinfectant is added from the first bulk storage tank (20) through the disinfectant flow line (20′) and disinfectant flow control member (14′) in a first mode to the flow in said second path section (8) of the water flow path and wherein (ii) water (5) in the first path section (6) from the reservoir (3) is permitted to enter the mixing unit (2) and flow continually therethrough to the third path section (10) of the water flowing back to the water (5) in said reservoir (3) with the control arrangement (4) positioning the disinfectant flow control member (14′) to prevent the addition of any disinfectant from the first bulk storage tank into the flow in said second path section (8), said control arrangement (4) operating the mixing unit in said second mode (ii) until a subsequent disinfectant mode (i) is initiated.

42. A water treatment system (1) for a reservoir (3) of water (5) including a mixing unit (2) located in a flow path of water (6,8,10) having at least first, second, and third path sections, said first path section (6) flowing from the water in said reservoir to said mixing unit, said second path section (8) flowing through the mixing unit, and said third path section (10) flowing back into the water in the reservoir from the mixing unit,
said mixing unit (2) having at least a first bulk storage tank (20) of disinfectant and a disinfectant flow line (20′) from the first bulk storage tank (20) of disinfectant to said second path section (8) flowing through the mixing unit with a disinfectant flow control member (14′) positioned between the disinfectant flow line (20′) and the second path section (8), said mixing unit further including a control arrangement (4) to selectively operate the mixing unit in at least two modes wherein (i) disinfectant is added from the first bulk storage tank (20) through the disinfectant flow line (20′) and disinfectant flow control member (14′) in a first mode to the flow in said second path section (8) of the water flow path and wherein (ii) water (5) in the first path section (6) from the reservoir (3) is permitted to enter the mixing unit (2) wherein the entering water (5) is hard water containing calcium and the mixing unit further includes a water softener arrangement (16) in the second path section (8) to remove calcium from the hard water from the first path section (6) wherein the water from the reservoir is softened and the control arrangement (4) of the mixing unit (2) is operable in the mode (ii) to flush at least a portion of the second path section (8) including the disinfectant flow control member (14′) with softened water with the control arrangement (4) positioning the disinfectant flow control member (14′) to prevent the addition of any disinfectant from the first bulk storage tank into the flow in said second path section (8).

43. A water treatment system (1) for a reservoir (3) of water (5) including a mixing unit (2) located in a flow path of water (6,8,10) having at least first, second, and third path sections, said first path section (6) flowing from the water in said reservoir to said mixing unit, said second path section (8) flowing through the mixing unit, and said third path section (10) flowing back into the water in the reservoir from the mixing unit,
said mixing unit (2) having at least a first bulk storage tank (20) of disinfectant and a disinfectant flow line (20′) from the first bulk storage tank (20) of disinfectant to said second path section (8) flowing through the mixing unit with a disinfectant flow control member (14′) positioned between the disinfectant flow line (20′) and the second path section (8), said mixing unit further including a control arrangement (4) to selectively operate the mixing unit in at least two modes wherein (i) water (5) in the first path section (6) from the reservoir (3) is permitted to enter the mixing unit (2) and flow therethrough to the third path section (10) of the water flow path back to the water (5) in said reservoir (3) in a first mode with the control arrangement (4) positioning the disinfectant flow control member (14′) to prevent the addition of any disinfectant from the first bulk storage tank in the second mode into the flow in said second path section (8) and wherein (ii) disinfectant is added from the first bulk storage tank (20) through the disinfectant flow line (20′) and disinfectant flow control member (14′) in a second mode to the flow in said second path section (8) of the water flow path,
said control arrangement (4) incrementally operating the mixing unit to add the disinfectant of mode (ii) in a series of doses with intermittent periods of operating the mixing unit in mode (i) with no disinfectant being added between the doses.

44. The water treatment system of claim 43 wherein the system includes a predetermined level of desired disinfectant in the reservoir water (5) based on an analysis of the reservoir water (5) by at least one analyzer (4′), the predetermined level being incrementally approached in said series of doses of mode (ii) wherein at least a first dose is set by the control arrangement (4) to fall short of the predetermined, desired level followed by the operation of the mode (i) and at least a second dose of mode (ii) is set to at least approach closer to the predetermined, desired level.

45. The water treatment system of claim 44 wherein the control arrangement (4) operates the mixing unit with at least a third dose of mode (ii) to approach closer to the predetermined, desired level without going beyond the predetermined, desired level.

46. The water treatment system of claim 44 wherein the system includes a predetermined level of desired disinfectant in the reservoir water (5) based on an analysis of the reservoir water (5) by at least one analyzer (4′) and the control arrangement (4) engages mode (i) at any time the reservoir water (5) approaches substantially 70%-80% of the predetermined, desired level.
